(19) United States
(12) Patent Application Publication
(10) Pub. No.: US 2017/0362263 A1
(43) Pub. Date: Dec. 21, 2017

(54) PHOSPHORUS LIGANDS AND METHODS OF USE

(71) Applicant: The Regents of the University of California, Oakland, CA (US)

(72) Inventors: Bruce H. Lipshutz, Santa Barbara, CA (US); Sachin Handa, Louisville, KY (US)

(73) Assignee: The Regents of the University of California, Oakland, CA (US)

(21) Appl. No.: 15/534,683

(22) PCT Filed: Dec. 9, 2015
(86) PCT No.: PCT/US2015/064643

§ 371 Date: Jun. 9, 2017

Related U.S. Application Data
(60) Provisional application No. 62/090,098, filed on Dec. 10, 2014.
(60) Provisional application No. 62/133,218, filed on Mar. 13, 2015.

(51) Int. Cl. C07F 9/6571; C07F 15/00; C07F 1/12

(52) U.S. Cl. CPC C07F 9/657163; C07F 1/12; C07F 15/006

(57) ABSTRACT

In one embodiment, the application discloses ligands, such as a ligand from a dihydrobenzo[1,3] oxaphosphole scaffold, and palladium complexes comprising the ligands and methods for performing cross coupling reactions and asymmetric cross coupling reactions with high selectivity and efficiency.

### RELATED APPLICATIONS

This application claims the benefit of U.S. Provisional Application No. 62/090,098, filed Dec. 10, 2014 and U.S. Provisional Application No. 62/133,218, filed Mar. 13, 2015.

### BACKGROUND OF THE INVENTION

The present invention relates to novel P-chiral monophosphorus ligands prepared from a dihydrobenzo[1,3]oxaphosphole scaffold and the preparation of metal complexes comprising the ligands as catalysts for applications in cross-coupling and related reactions. More particularly, the present invention relates to these phosphine ligands and the catalysts prepared from the phosphine ligands for performing transition metal catalyzed cross-coupling reactions including carbon-carbon bond forming reactions and C—X cross-coupling reactions.

Metal-catalyzed cross-coupling reactions have become one of the most important transformations in organic chemistry. A. de Meijere, F. Diederich, Eds. Metal-Catalyzed Cross-Coupling Reactions, Vol. 2: Wiley-VCH, Weinheim, 2004. J.-P. Corbet, G. Mignani, Chem. Rev. 2006, 106, 2651.

Development of efficient chiral or nonchiral ligands for metal-catalyzed cross-coupling has gained particular attention in the last twenty years. It has been demonstrated that the ligands play essential roles in the catalytic cycle including oxidative addition, transmetallation and reductive elimination. In addition, the steric and electronic properties of the ligand can greatly influence the rate, regioselectivity and stereoselectivity of the cross-coupling reactions. See, for example, S. L. Buchwald et al., J. Am. Chem. Soc. 2005, 127, 4685; S. L. Buchwald et al., Angew. Chem., Int. Ed. 2004, 43, 1871; S. L. Buchwald et al., J. Am. Chem. Soc. 2007, 129, 3358; S. L. Buchwald et al., WO2009/076622; J. F. Hartwig et al., WO 2002/011883; J. F. Hartwig et al., J. Am. Chem. Soc. 1996, 118, 7217; G. C. Fu et al., J. Am. Chem. Soc. 2001, 123, 10099; and Beller et al., Angew. Chem., Int. Ed. 2000, 39, 4153; M. Beller et al., Chem. Comm. 2004, 38. These researchers have developed efficient ligands for cross-coupling reactions including carbon-carbon bond forming reactions and C—X cross-coupling reactions.

The Suzuki-Miyaura coupling reaction is one of most useful method for the formation of carbon-carbon bonds and has been used in numerous synthetic processes. See N. Miyaura, Topics in Current Chem. 2002, 219, 11 and A. Suzuki, Organomet. Chem. 1999, 576, 147. Despite the recent advances on this reaction, the Suzuki-Miyaura coupling of sterically hindered substrates and catalyst loading have not been fully optimized. Development of new ligands for cross coupling reactions, such as the Suzuki-Miyaura coupling reaction, remains an important goal for increasing the efficiency of such reactions. Other common cross-couplings to which this invention applies, in particular, include Sonogashira and amination reactions.

### SUMMARY OF THE INVENTION

There is a continuing need for novel ligands and palladacycles comprising the ligands for performing efficient and selective cross coupling reactions. The following embodiments, aspects and variations thereof are exemplary and illustrative are not intended to be limiting in scope.

In one embodiment, the present application discloses a series of novel, effective and selective chiral (both racemic and nonracemic) monophosphorous-containing ligands derived from a dihydrobenzo[1,3]oxaphosphole scaffold that provides superior results for cross coupling reactions, such as Suzuki coupling or asymmetric Suzuki reaction. As disclosed in the present application, the use of the ligands provide high reactivity and selectivity for such coupling reactions, such as the Suzuki-Miyaura, Sonogashira and amination coupling reactions.

In one embodiment, there is provided a ligand of the formula Ia, Ib, Ic or Id:

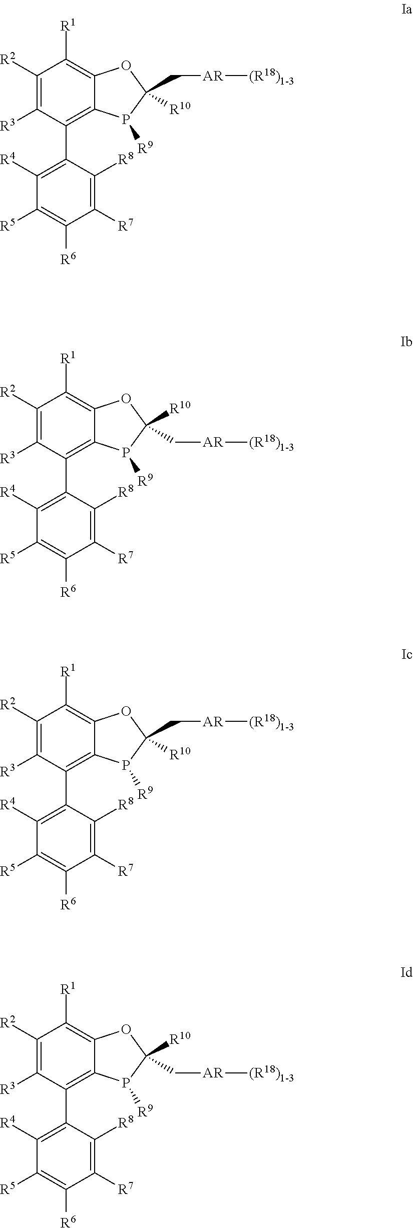

wherein:

AR is an unsubstituted or substituted (C₆₋₁₀)aryl or (C₅₋₁₁)heteroaryl group;

R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;

R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, —(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycloalkyl, aryl or heteroaryl ring;

R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;

R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;

R¹⁶ and R¹⁷ are each independently selected from the group consisting of hydrogen, perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted; and

each R¹⁸ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted; as a single diastereomer or a mixture of diastereomers.

In one variation of the ligand, each alkyl, alkenyl, alkynyl, cycloalkyl, heterocycloalkyl, aryl and heteroaryl are substituted by 1 or 2 substituents selected from the group consisting of halo, —CN, —NO₂, trifluoromethyl, trifluoromethoxy, methoxy, —COOH, —NH₂, —OH, —SH, —SMe, —NH(CH₃)₂ and —N(CH₃)₂. In another variation, at least one of R⁴, R⁵, R⁶, R⁷ and R⁸ is —OR¹⁶.

In one aspect of the above ligand, AR is selected from the group consisting of phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole, each of which is unsubstituted or substituted with 1, 2 or 3 substituents selected from the group consisting of C₁₋₁₀alkyl, perhalo(C₁₋₃)alkyl, —O(C₁₋₁₀)alkyl, (C₂₋₁₀)alkenyl, (C₂₋₁₀)alkynyl and (C₃₋₁₂)cycloalkyl; and R¹⁰ is hydrogen.

In one variation, the phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole group is substituted by one or two substituents where the substituent is selected from the group consisting of halo, —CN, —NO₂, trifluoromethyl, trifluoromethoxy, methoxy, —COOH, —NH₂, —OH, —SH, —SMe, —NH(CH₃)₂ and —N(CH₃)₂.

In another variation, the substituents is substituted at an adjacent or ortho position to the ring (e.g., 2-CN-phenyl), or where an open valence is permitted, at a meta position (e.g., 3-CN-phenyl), or at a para position (e.g., 4-CN-phenyl). In one variation, the phenyl ring may be substituted at the 2, 4 and 6-positions. In another variation, R⁹ is selected from the group consisting of phenyl, o-tolyl, p-tolyl, 3,5-dimethylphenyl, 3,5-di-t-butylphenyl, 3,5-di-CF₃-phenyl, 2-CF₃-phenyl, 2-MeO-phenyl, 1-naphthyl and 2-naphthyl.

In another embodiment, the application provides a ligand of the formula IIa, IIb, IIc or IId:

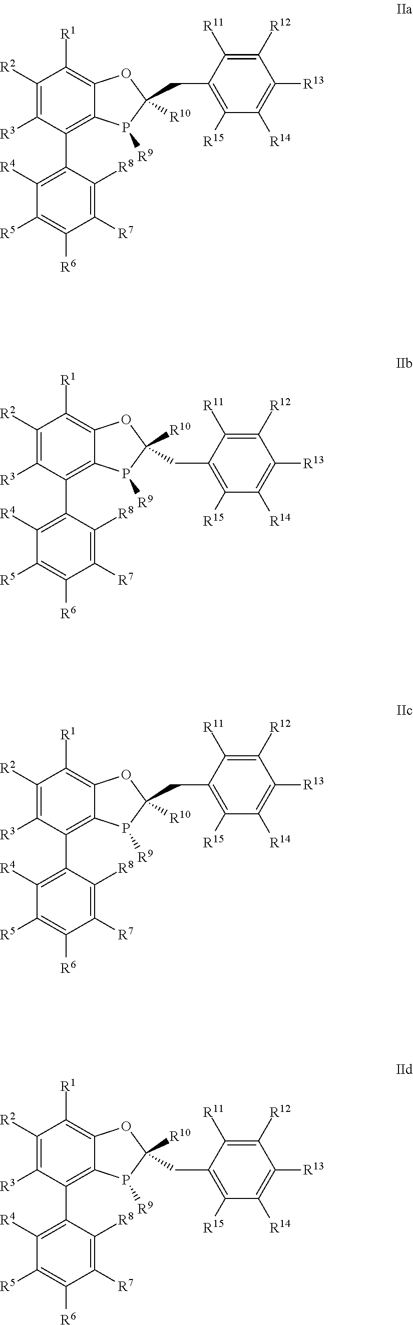

wherein:

R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;

R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycloalkyl, aryl or heteroaryl ring;

R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;

R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;

each R¹¹, R¹², R¹³, R¹⁴ and R¹⁵ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted; and

R¹⁶ and R¹⁷ are each independently selected from the group consisting of hydrogen, perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted; as a single diastereomer or a mixture of diastereomers.

In one variation of the ligand, each alkyl, alkenyl, alkynyl, cycloalkyl, heterocycloalkyl, aryl and heteroaryl are substituted by 1 or 2 substituents selected from the group consisting of halo, —CN, —NO₂, trifluoromethyl (—CF₃), trifluoromethoxy, methoxy, —COOH, —NH₂, —OH, —SH, —SMe, —NH(CH₃)₂ and —N(CH₃)₂. In another variation, at least one of R⁴, R⁵, R⁶, R⁷ and R⁸ is —OR¹⁶. In another variation, the ligand is phenyl and is substituted by two —CF₃ groups at the 3- and 5-position of the phenyl group.

In one aspect of the above ligand, R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, cycloalkyl, aryl(C₁₋₁₀)alkyl, (C₉₋₁₂)bicycloaryl, (C₆₋₁₀)aryl, wherein each alkyl, alkenyl, alkynyl, cycloalkyl and aryl are unsubstituted or substituted with 1, 2 or 3 substituents selected from the group consisting of perhalo(C₁₋₃)alkyl, (C₁₋₁₀)alkyl and —O(C₁₋₁₀)alkyl.

In another aspect of the ligand, R⁹ is selected from the group consisting of —CH₃, —OCH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropy, cyclopentyl and -cyclohexyl.

In another aspect of the ligand, R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, cyclopentyl and -cyclohexyl;

R¹⁰ is hydrogen; and R¹¹, R¹³ and R¹⁵ are each selected from the group consisting of —CH₃, —CH(CH₃)₂, —C(CH₃)₃, —C(CH₃)₂(CH₂CH₃), —C(CH₃)(CH₂CH₃)₂, —CH(CH(CH₃)₂) and —OCH₃.

In another aspect of the ligand, R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, -cyclopentyl and -cyclohexyl; and R⁴, R⁶ and R⁸ are each independently selected from the group consisting of hydrogen, (C₁₋₁₀)alkyl and —O(C₁₋₆)alkyl.

In another aspect, the ligand is selected from the group consisting of IIIa, IIIb, IIIc, IIId, IIIe, IIIf, IIIg and IIIk:

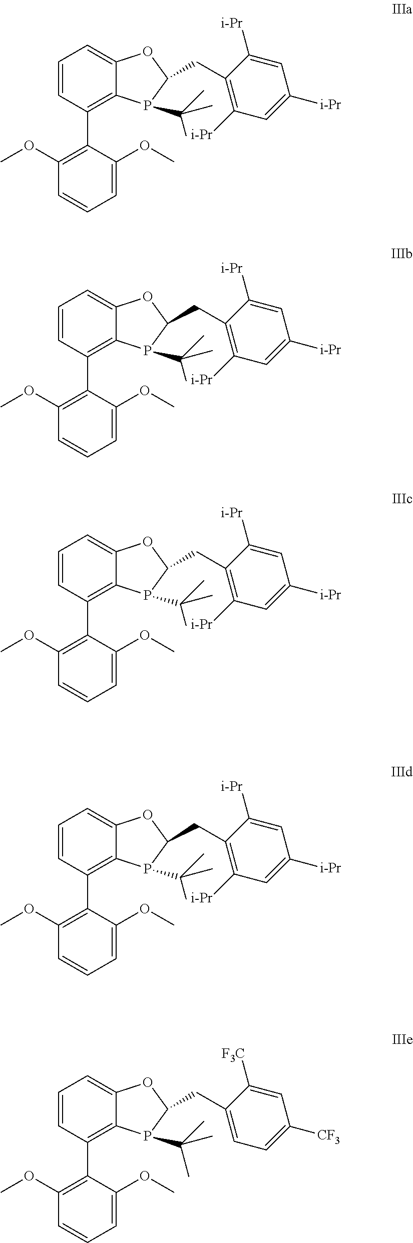 [SMILES: COc1cccc(OC)c1-c1cccc2c1[P@](C(C)(C)C)[C@@H](Cc1c(C(C)C)cc(C(C)C)cc1C(C)C)O2 ; COc1cccc(OC)c1-c1cccc2c1[P@](C(C)(C)C)[C@H](Cc1c(C(C)C)cc(C(C)C)cc1C(C)C)O2 ; COc1cccc(OC)c1-c1cccc2c1[P@@](C(C)(C)C)[C@@H](Cc1c(C(C)C)cc(C(C)C)cc1C(C)C)O2 ; COc1cccc(OC)c1-c1cccc2c1[P@@](C(C)(C)C)[C@H](Cc1c(C(C)C)cc(C(C)C)cc1C(C)C)O2 ; COc1cccc(OC)c1-c1cccc2c1[P@](C(C)(C)C)[C@@H](Cc1ccc(C(F)(F)F)cc1C(F)(F)F)O2]

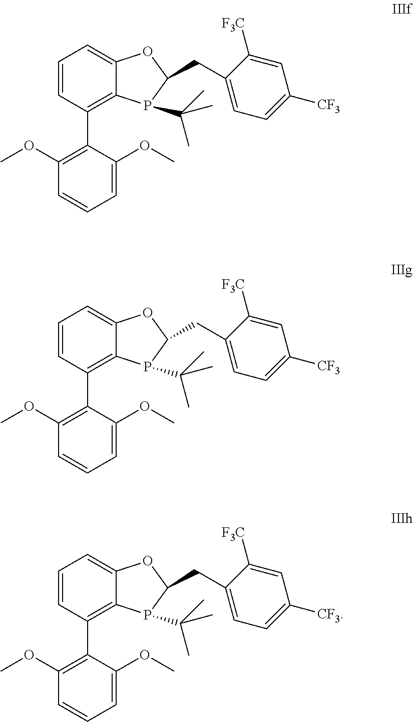 [SMILES: COc1cccc(OC)c1-c1cccc2c1[P@](C(C)(C)C)[C@H](Cc1ccc(C(F)(F)F)cc1C(F)(F)F)O2 ; COc1cccc(OC)c1-c1cccc2c1[P@@](C(C)(C)C)[C@@H](Cc1ccc(C(F)(F)F)cc1C(F)(F)F)O2 ; COc1cccc(OC)c1-c1cccc2c1[P@@](C(C)(C)C)[C@H](Cc1ccc(C(F)(F)F)cc1C(F)(F)F)O2]

In another embodiment, the application provides a palladacycle of the formula IVa, IVb, IVc or IVd:

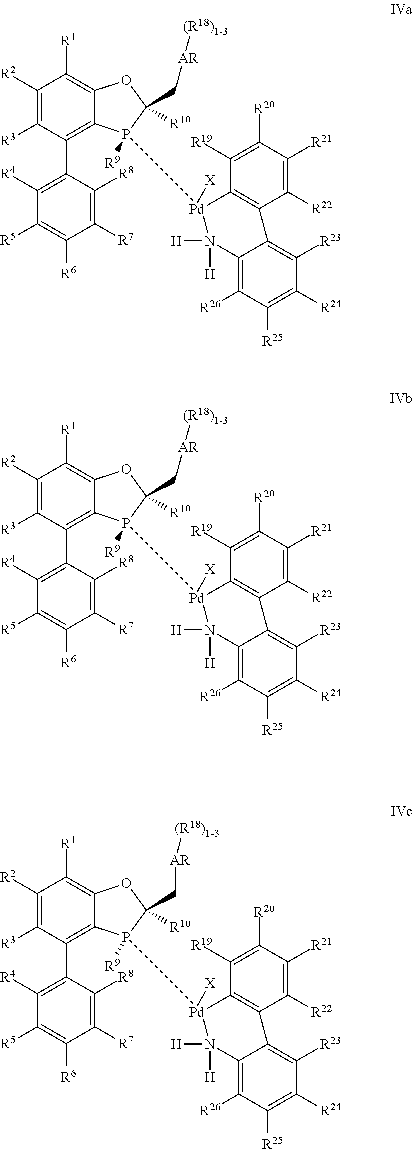

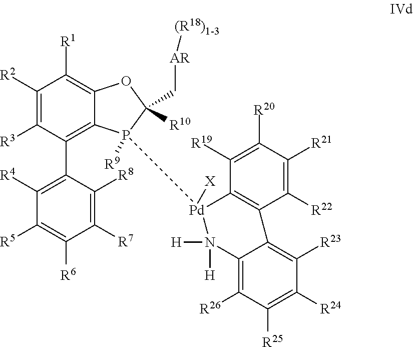

wherein:

AR is an unsubstituted or substituted (C₆₋₁₀)aryl or (C₅₋₁₁)heteroaryl group;

X is selected from the group consisting of Br, Cl, I, TsO— and MesO—;

R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;

R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycoalkyl, aryl or heteroaryl ring;

R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;

R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;

R¹⁶ and R¹⁷ are each independently selected from the group consisting of hydrogen, perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;

each R¹⁸ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted;

R¹⁹, R²⁰, R²¹ and R²² are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cyeloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted; and

R²³, R²⁴, R²⁵ and R²⁶ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted; as a single diastereomer or a mixture of diastereomers.

In one variation of each of the above, -AR—R¹⁸)₁₋₃ is 3-, 5-di-(CF₃)phenyl-.

In one variation, R²⁵ is selected from the group consisting of perhalo(C₁₋₃)alkyl, (C₁₋₁₀)alkyl, (C₂₋₁₀)alkenyl, (C₂₋₁₀)alkynyl and (C₃₋₁₂)cycloalkyl, wherein each alkyl, alkenyl, alkynyl and cycloalkyl are unsubstituted or substituted with 1 or 2 substituents selected from halo, —CN, —NO₂, trifluoromethyl, trifluoromethoxy, methoxy, —COOH, —NH₂, —OH, —SH, —SMe, —NH(CH₃)₂ and —N(CH₃)₂.

In one aspect of the above palladacycle, AR is selected from the group consisting of phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole, each of which is unsubstituted or substituted with 1, 2 or 3 substituents selected from the group consisting of C₁₋₁₀alkyl, perhalo(C₁₋₃)alkyl, —O(C₁₋₁₀)alkyl, (C₂₋₁₀)alkenyl, (C₂₋₁₀)alkynyl and (C₃₋₁₂)cycloalkyl; and R¹⁰ is hydrogen.

In another variation, the phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole group is substituted by one substituent at an adjacent or ortho position, where the substituent is selected from the group consisting of halo, —CN, —NO₂, trifluoromethyl, trifluoromethoxy, methoxy, —COOH, —NH₂, —OH, —SH, —SMe, —NH(CH₃)₂ and —N(CH₃)₂. In another variation, at least one of R⁴, R⁵, R⁶, R⁷ and R⁸ is —OR¹⁶.

In one aspect of the above palladacycle, X is selected from the group consisting of Cl, TsO— and MesO—; R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, cycloalkyl, aryl(C₁₋₁₀)alkyl, (C₉₋₁₂)bicycloaryl, (C₆₋₁₀)aryl, wherein each alkyl, alkenyl, alkynyl, cycloalkyl and aryl are unsubstituted or substituted with 1, 2 or 3 substituents selected from the group consisting of perhalo(C₁₋₃)alkyl, (C₁₋₁₀)alkyl and —O(C₁₋₁₀)alkyl.

In another aspect of the palladacycle, R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, cyclopentyl and -cyclohexyl.

In another aspect of the palladacycle, R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, cyclopentyl and -cyclohexyl; R¹⁰ is hydrogen; and R⁴ and R⁸ are each —CH(CH₃)₂ or —OCH₃.

In another aspect of the palladacycle, R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, -cyclopentyl and -cyclohexyl; and R⁴, R⁶ and R⁸ are each independently selected from the group consisting of hydrogen, (C₁₋₁₀)alkyl and —O(C₁₋₆)alkyl. In another aspect of the palladacycle, R¹⁹, R²⁰, R²¹ and R²² are hydrogen; and R²⁵ is selected from the group consisting of perhalo(C₁₋₃)alkyl, (C₁₋₁₀)alkyl, (C₂₋₁₀)alkenyl, (C₂₋₁₀)alkynyl and (C₃₋₁₂)cycloalkyl.

In another embodiment, the application provides a palladacycle of the formula Va, Vb, Vc or Vd:

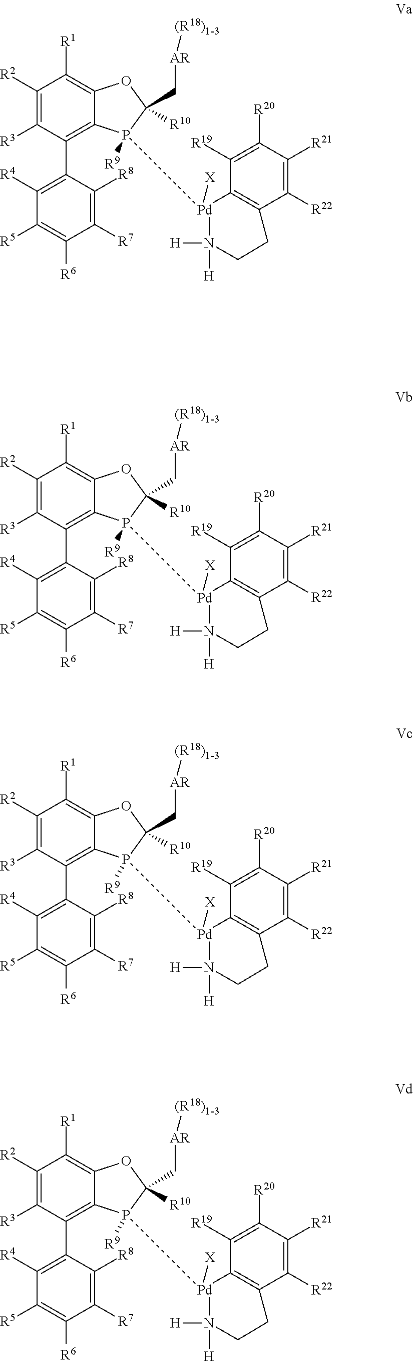

wherein:

AR is an unsubstituted or substituted (C₆₋₁₀)aryl or a (C₅₋₁₁)heteroaryl group;

X is selected from the group consisting of Br, Cl, I, TsO— and MesO—;

R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)₁₋₂(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;

R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycloalkyl, aryl or heteroaryl ring;

R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;

R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;

R¹⁶ and R¹⁷ are each independently selected from the group consisting of hydrogen, perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₆₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;

each R¹⁸ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted; and

R¹⁹, R²⁰, R²¹ and R²² are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted; as a single diastereomer or a mixture of diastereomers.

In one variation of the palladacyle, each alkyl, alkenyl, alkynyl, cycloalkyl, heterocycloalkyl, aryl and heteroaryl are substituted by 1 or 2 substituents selected from the group consisting of halo, —CN, —NO₂, trifluoromethyl, trifluoromethoxy, methoxy, —COOH, —NH₂, —OH, —SH, —SMe, —NH(CH₃)₂ and —N(CH₃)₂. In another variation, at least one of R⁴, R⁵, R⁶, R⁷ and R⁸ is —OR¹⁶.

In one aspect of the above palladacycle, AR is selected from the group consisting of phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole, each of which is unsubstituted or substituted with 1, 2 or 3 substituents selected from the group consisting of C₁₋₁₀alkyl, perhalo(C₁₋₃)alkyl, —O(C₁₋₁₀)alkyl, (C₂₋₁₀)alkenyl, (C₂₋₁₀)alkynyl and (C₃₋₁₂)cycloalkyl; and R¹⁰ is hydrogen.

In one variation, the phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole group is substituted by one substituent at an adjacent or ortho position, where the substituent is selected from the group consisting of halo, —CN, —NO₂, trifluoromethyl, trifluoromethoxy, methoxy, —COOH, —NH₂, —OH, —SH, —SMe, —NH(CH₃)₂ and —N(CH₃)₂.

In one aspect of the palladacycle, AR is phenyl substituted by 1, 2 or 3 R¹⁸; X is selected from the group consisting of Cl, TsO— and MesO—; and

R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, cycloalkyl, aryl(C₁₋₁₀)alkyl, (C₉₋₁₂)bicycloaryl, (C₆₋₁₀)aryl, wherein each alkyl, alkenyl, alkynyl, cycloalkyl and aryl are unsubstituted or substituted with 1, 2 or 3 substituents selected from the group consisting of perhalo(C₁₋₃)alkyl, (C₁₋₁₀)alkyl and —O(C₁₋₁₀)alkyl.

In another aspect of the palladacycle, R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂) and -cyclohexyl.

In another aspect of the palladacycle, R⁴ and R⁸ are —OCH₃ or —CH(CH₃)₂; R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂) and -cyclohexyl; and R¹⁰ is hydrogen.

In another aspect of the palladacycle, R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, -cyclopentyl and -cyclohexyl; and R⁴, R⁶ and R⁸ are each independently selected from the group consisting of hydrogen, (C₁₋₁₀)alkyl and —O(C₁₋₆)alkyl. In another aspect of the palladacycle, R¹⁹, R²⁰, R²¹ and R²² are each independently selected from hydrogen, —OCH₃, —CH₃, —CH₂CH₃, —CH₂CH₂CH₃, —CH(CH₃)₂ and —C(CH₃)₃.

In another embodiment, the application provides a palladacycle catalyst prepared from the reaction of a ligand of any one of the above embodiments, aspects and variations, with a transition metal salt or a metal complex thereof, comprising contacting the ligand with the transition metal salt or the metal complex in a solvent for a sufficient period of time to form the palladacycle catalyst.

In one variation, the ligand is a chiral ligand, as a substantially pure diastereomer or a mixture of diastereomers. In another variation, the solvent is selected from the group consisting of THF, ether, dioxane, di-butylether, toluene, DCM or mixtures thereof.

In one aspect of the above palladacycle, the metal complex is:

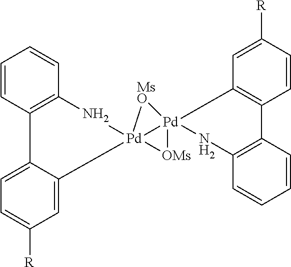

wherein R is selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted.

In one aspect of the palladacycle, the ligand is selected from the group consisting of IIIA, IIIb, IIIc, IIId, IIIe, IIIf, IIIg and IIIb, or mixtures thereof:

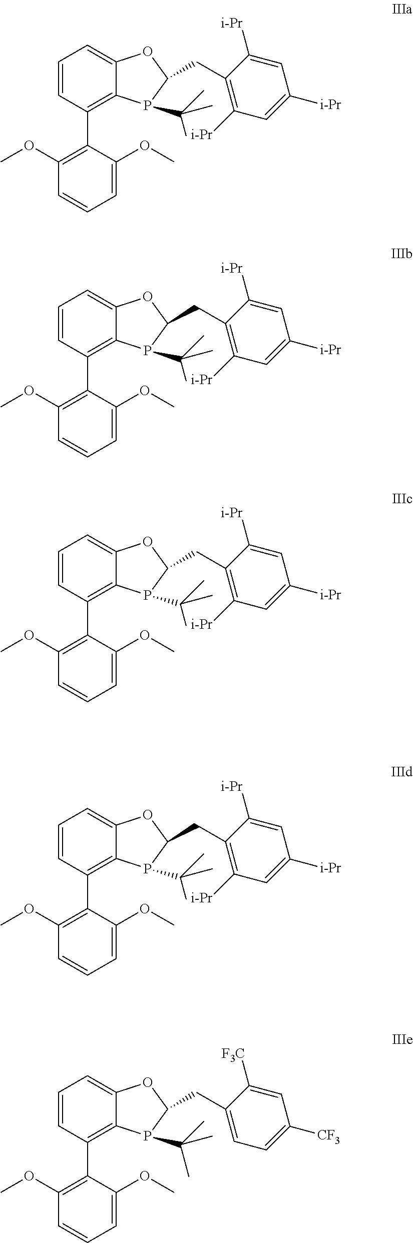 [SMILES: COc1cccc(OC)c1-c1cccc2c1[P@](C(C)(C)C)[C@@H](Cc1c(C(C)C)cc(C(C)C)cc1C(C)C)O2 ; COc1cccc(OC)c1-c1cccc2c1[P@](C(C)(C)C)[C@H](Cc1c(C(C)C)cc(C(C)C)cc1C(C)C)O2 ; COc1cccc(OC)c1-c1cccc2c1[P@@](C(C)(C)C)[C@@H](Cc1c(C(C)C)cc(C(C)C)cc1C(C)C)O2 ; COc1cccc(OC)c1-c1cccc2c1[P@@](C(C)(C)C)[C@H](Cc1c(C(C)C)cc(C(C)C)cc1C(C)C)O2 ; COc1cccc(OC)c1-c1cccc2c1[P@](C(C)(C)C)[C@@H](Cc1ccc(C(F)(F)F)cc1C(F)(F)F)O2]

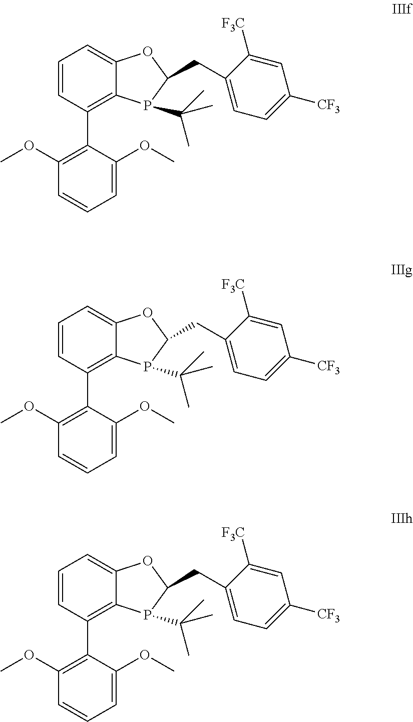 [SMILES: COc1cccc(OC)c1-c1cccc2c1[P@](C(C)(C)C)[C@H](Cc1ccc(C(F)(F)F)cc1C(F)(F)F)O2 ; COc1cccc(OC)c1-c1cccc2c1[P@@](C(C)(C)C)[C@@H](Cc1ccc(C(F)(F)F)cc1C(F)(F)F)O2 ; COc1cccc(OC)c1-c1cccc2c1[P@@](C(C)(C)C)[C@H](Cc1ccc(C(F)(F)F)cc1C(F)(F)F)O2]

In another embodiment, the application provides a method for performing a cross coupling reaction comprising contacting a palladacycle of any one of the above embodiments, aspects and variations, with a first amine substrate with a second halide substrate or with a second sulfonate substrate for a sufficient period of time to form the cross coupling product.

In one variation, the second sulfonate substrate is an alkyl mesylate, an aryl mesylate, an alkyl CF₃-sulfonate, an aryl CF₃-sulfonate, an alkyl tosylate or an aryl tosylate.

In one aspect of the above method, the first amine substrate is selected from the group consisting of alkyl amines or aryl amines, and the second halide substrate is selected from the group consisting of an alkyl halide, an aryl halide, an alkyl mesylate and an aryl mesylate. In one variation of the method, the second halide substrate is a substrate comprising a chloride, bromide or iodide.

In one aspect of the above method, the cross coupling reaction is a Suzuki-Miyaura cross coupling reaction. In another aspect of the method, the second sulfonate substrate is an aryl sulfonate or a heteroaryl sulfonate. In another aspect of the method, the cross coupling reaction is performed in an aqueous medium. In one variation, there is provided a method for performing the above cross coupling reactions comprising a catalysis based on other metals, including precious metals such as gold, rhodium, iridium and ruthenium.

In one variation of the above method, the ligand-catalyst of the present application may be employed at a ppm level, such 1,000 ppm, 500 ppm, 300 ppm, 200 ppm, 100 ppm or less.

In one embodiment, the present application discloses a ligand, HandaPhos, as a substantially pure diastereomer, or a mixture of diastereomers.

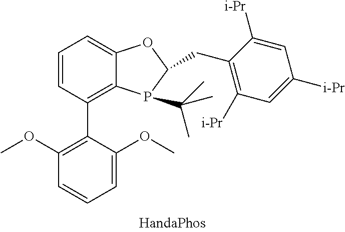 [SMILES: COc1cccc(OC)c1-c1cccc2c1[P@](C(C)(C)C)[C@@H](Cc1c(C(C)C)cc(C(C)C)cc1C(C)C)O2]

In another variation, the application discloses the palladacycle-1 and palladacycle-2, as follows:

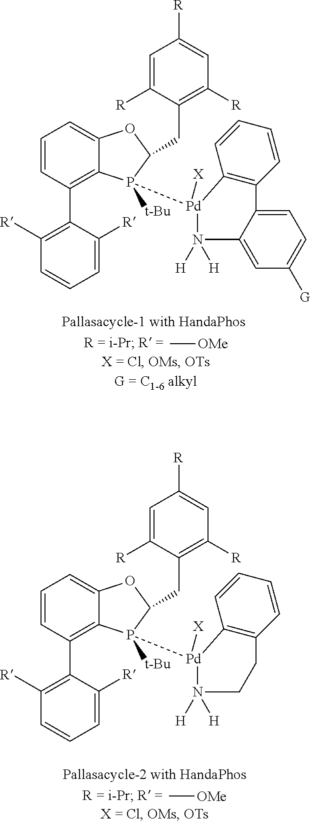

In another embodiment, there is provided a method for performing a transition metal mediated bond formation to form a coupling product, the method comprising contacting a coupling substrate with a mixture comprising:

(a) water in an amount of at least 1% wt/wt of the mixture;

(b.1) a palladacycle of the formula IVa, IVb, IVc or IVd:

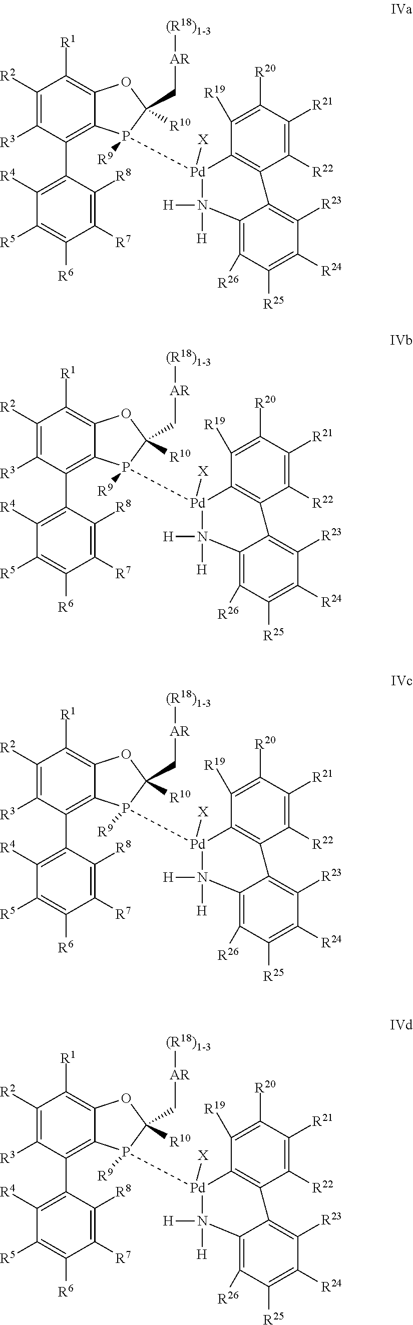

wherein:

AR is an unsubstituted or substituted (C₆₋₁₀)aryl or (C₅₋₁₁)heteroaryl group;

X is selected from the group consisting of Br, Cl, I, TsO— and MesO—;

R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;

R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycoalkyl, aryl or heteroaryl ring;

R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;

R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;

R¹⁶ and R¹⁷ are each independently selected from the group consisting of hydrogen, perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;

each R¹⁸ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted;

R¹⁹, R²⁰, R²¹ and R²² are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cyeloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted; and

R²³, R²⁴, R²⁵ and R²⁶ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cyeloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted; as a single diastereomer or a mixture of diastereomers; or

(b.2) a palladacycle of the formula Va, Vb, Vc or Vd:

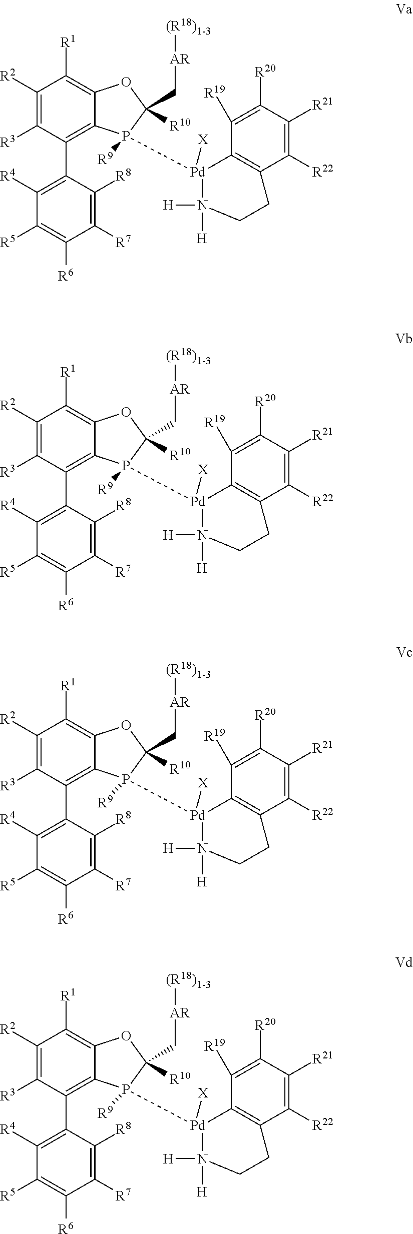

wherein:

AR is an unsubstituted or substituted (C₆₋₁₀)aryl or a (C₅₋₁₁)heteroaryl group;

X is selected from the group consisting of Br, Cl, I, TsO— and MesO—;

R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)₁₋₂(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;

R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycloalkyl, aryl or heteroaryl ring;

R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;

R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;

R¹⁶ and R¹⁷ are each independently selected from the group consisting of hydrogen, perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀) aryl and (C₅₋₁₁)heteroaryl, wherein each alkyl, alkenyl, alkynyl, cycloalkyl, heterocycloalkyl, aryl and heteroaryl are unsubstituted or substituted;

each R¹⁸ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted; and

R¹⁹, R²⁰, R²¹ and R²² are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted; as a single diastereomer or a mixture of diastereomers; and

(c) one or more solubilizing agents selected from the group consisting of solubilizing agents having a hydrophilic-lipophilic balance (HLB) of 8-18, HLB of 7-9, HLB of 8-12 or HLB of 13-15, or a solubilizing agent having the formula

Y¹-L¹-Z

wherein Z is a natural or synthetic alpha-tocopherol, or a ubiquinol moiety containing a covalently bound catalyst,

and Y¹-L¹- has the formula:

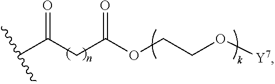

wherein n is an integer selected from 1-14,

k is an integer selected from 1-250, and

Y⁷ is selected from H and methyl, or mixtures of solubilizing agents;

under conditions appropriate to form a bond between a first atom of the coupling substrate and a second atom of a member selected from (i) the coupling substrate and (ii) a coupling partner to form the coupling product.

In one variation of the above method, AR is selected from the group consisting of phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole, each of which is unsubstituted or substituted with 1, 2 or 3 substituents selected from the group consisting of C₁₋₁₀alkyl, perhalo(C₁₋₃)alkyl, —O(C₁₋₁₀)alkyl, (C₂₋₁₀)alkenyl, (C₂₋₁₀)alkynyl and (C₃₋₁₂)cycloalkyl; and R¹⁰ is hydrogen.

In another variation of the above method, wherein the palladacycle has a structure wherein X is selected from the group consisting of Cl, TsO— and MesO—; and R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, cycloalkyl, aryl(C₁₋₁₀)alkyl, (C₉₋₁₂)bicycloaryl, (C₆₋₁₀)aryl, wherein each alkyl, alkenyl, alkynyl, cycloalkyl and aryl are unsubstituted or substituted with 1, 2 or 3 substituents selected from the group consisting of perhalo(C₁₋₃)alkyl, (C₁₋₁₀)alkyl and —O(C₁₋₁₀)alkyl.

In another variation of the above method, wherein the palladacycle has a structure wherein R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, cyclopentyl and -cyclohexyl.

In another variation of the above method, wherein the palladacycle has a structure wherein: R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, cyclopentyl and -cyclohexyl; R¹⁰ is hydrogen; and R⁴ and R⁸ are each —CH(CH₃)₂ or —OCH₃.

In another variation of the above method, wherein the palladacycle has a structure wherein: R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, -cyclopentyl and -cyclohexyl; and R⁴, R⁶ and R⁸ are each independently selected from the group consisting of hydrogen, (C₁₋₁₀)alkyl and —O(C₁₋₆)alkyl.

In another variation of the above method, wherein the palladacycle has a structure wherein: R¹⁹, R²⁰, R²¹ and R²² are hydrogen; and R²⁵ is selected from the group consisting of perhalo(C₁₋₃)alkyl, (C₁₋₁₀)alkyl, (C₂₋₁₀)alkenyl, (C₂₋₁₀)alkynyl and (C₃₋₁₂)cycloalkyl.

In yet another variation of the above method, wherein the palladacycle has a structure where AR is selected from the group consisting of phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole, each of which is unsubstituted or substituted with 1, 2 or 3 substituents selected from the group consisting of C₁₋₁₀alkyl, perhalo(C₁₋₃)alkyl, —O(C₁₋₁₀)alkyl, (C₂₋₁₀)alkenyl, (C₂₋₁₀)alkynyl and (C₃₋₁₂)cycloalkyl; and R¹⁰ is hydrogen.

In yet another variation of the above method, wherein the palladacycle has a structure where AR is phenyl substituted by 1, 2 or 3 R¹⁸; X is selected from the group consisting of Cl, TsO— and MesO—; and R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, cycloalkyl, aryl(C₁₋₁₀)alkyl, (C₉₋₁₂)bicycloaryl, (C₆₋₁₀)aryl, wherein each alkyl, alkenyl, alkynyl, cycloalkyl and aryl are unsubstituted or substituted with 1, 2 or 3 substituents selected from the group consisting of perhalo(C₁₋₃)alkyl, (C₁₋₁₀)alkyl and —O(C₁₋₁₀)alkyl. In yet another variation of the above method, wherein the palladacycle has a structure where R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂) and -cyclohexyl.

In yet another variation of the above method, wherein the palladacycle has a structure where R⁴ and R⁸ are —OCH₃ or —CH(CH₃)₂; R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂) and -cyclohexyl; and R¹⁰ is hydrogen. In yet another variation of the above method, wherein the palladacycle has a structure where R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, -cyclopentyl and -cyclohexyl; and R⁴, R⁶ and R⁸ are each independently selected from the group consisting of hydrogen, (C₁₋₁₀)alkyl and —O(C₁₋₆)alkyl.

In yet another variation of the above method, wherein the palladacycle has a structure where R¹⁹, R²⁰, R²¹ and R²² are each independently selected from hydrogen, —OCH₃, —CH₃, —CH₂CH₃, —CH₂CH₂CH₃, —CH(CH₃)₂ and —C(CH₃)₃.

A method for performing a transition metal mediated bond formation to form a coupling product, the method comprising contacting a coupling substrate with a mixture comprising:

(a) water in an amount of at least 1% wt/wt of the mixture;

(b) a catalyst of the formula VIa, VIb, VIc or VId:

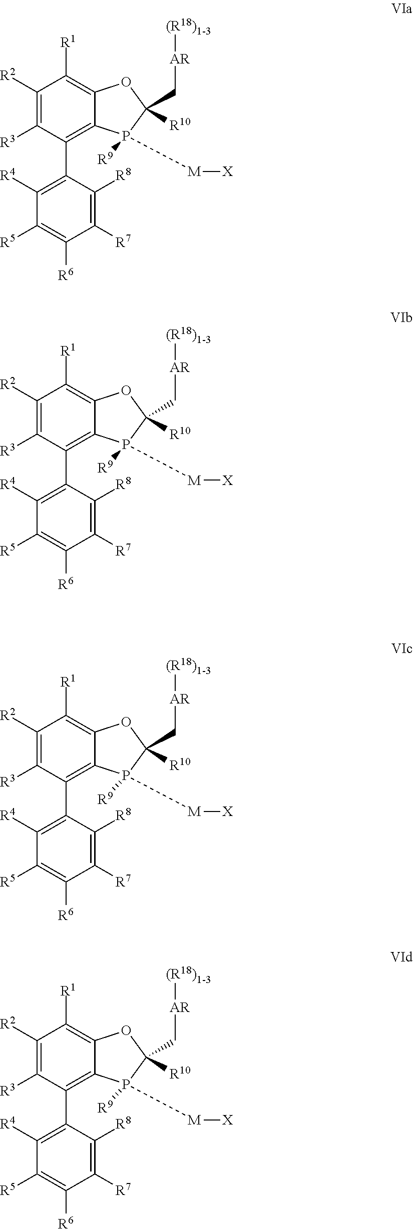

wherein:

AR is an unsubstituted or substituted (C₆₋₁₀)aryl or (C₅₋₁₁)heteroaryl group;

M is a metal selected from the group consisting of Au, Ag, Cd, Co, Cu, Fe, Ir, Ni, Os, Pt, Rh, Ru and Zn in all of the metal's standard oxidation states;

X is selected from the group consisting of Br, Cl, I, TsO— and MesO—;

R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;

R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycoalkyl, aryl or heteroaryl ring;

R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;

R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted; and

each R¹⁸ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted; and

(c) one or more solubilizing agents selected from the group consisting of solubilizing agents having a hydrophilic-lipophilic balance (HLB) of 8-18, HLB of 7-9, HLB of 8-12 or HLB of 13-15, or a solubilizing agent having the formula

Y¹-L¹-Z

wherein Z is a natural or synthetic alpha-tocopherol, or a ubiquinol moiety containing a covalently bound catalyst,

and Y¹-L¹- has the formula:

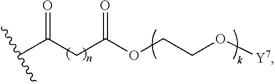

wherein n is an integer selected from 1-14,

k is an integer selected from 1-250, and

Y⁷ is selected from H and methyl, or mixtures of solubilizing agents;

under conditions appropriate to form a bond between a first atom of the coupling substrate and a second atom of a member selected from (i) the coupling substrate and (ii) a coupling partner to form the coupling product.

In one variation of the above method, the catalyst comprising the phosphine ligated gold complexes, such as gold (I) complexes, may be used in a variety of different transformations, including: 1) C—C, C—N and C—O bond forming reactions since the complexes can activate C═C and C═C bonds, resulting in unique rearrangements or reactions with various nucleophiles. See for example, Shapiro, N. D.; Toste, F. D. J. Am. Chem. Soc., 2007, 129, 4160 and Hashmi, A. S. K.; Hutchings, G. J. Angew. Chem., Int. Ed. 2006, 45, 7896; 2) the catalyzed isomerization of allylic acetates, and may be used with a N-heterocyclic carbine ligand (Marion, N. et al. Org. Lett. 2007, 9, 2653; 3) the synthesis of a series of 1,3-butadien-2-ol from different allenes using a gold complex as catalys (Buzas, A. K. et al. Org. Lett. 2007, 9, 985); 4) catalysis of [4+2] cycloaddition of dienynes (Nieto-Oberhuber, C. et al. J. Am. Chem. Soc. 2008, 130, 2690); 5) stereoselective cyclopropanation (cis) with propargyl esters and complements to the trans selectivity observed in transition metal catalyzed cyclopropanation of olefins using α-diazoacetates; 6) isomerization of 1,4-, 1,5 and 1,6-enynes; 7) cyclization of ε-acetylenic carbonyls; 8) Claisen rearrangement of a propargyl vinyl ether; 9) intra- and intermolecular hydroamination reactions with alkenes and alkynes; 10) hydrofunctionalization of allenes with C, N, and O nucleophiles; and 11) stereoselective synthesis of functionalized dihydrofurans. See Hashmi, A. S. K. Chem. Rev. 2007, 107, 3180.

In another aspect of the above method, the transition metal mediated bond formation is performed in an aqueous solvent. In another aspect of the method, the coupling substrate is selected from substituted or unsubstituted alkyl, substituted or unsubstituted heteroalkyl, substituted or unsubstituted cycloalkyl, substituted or unsubstituted heterocycloalkyl, substituted or unsubstituted aryl and substituted or unsubstituted heteroaryl; and wherein the coupling partner is selected from H, substituted or unsubstituted amine, substituted or unsubstituted silane, substituted or unsubstituted alkyl, substituted or unsubstituted heteroalkyl, substituted or unsubstituted cycloalkyl, substituted or unsubstituted heterocycloalkyl, substituted or unsubstituted aryl and substituted or unsubstituted heteroaryl.

In another aspect of the method, the coupling substrate is a substituted or unsubstituted alkene, a substituted or unsubstituted alkyne, a substituted or unsubstituted enyne, a substituted or unsubstituted enone or enoate or a substituted or unsubstituted ynone or ynoate. In another aspect of the method, the coupling substrate is selected from a substituted or unsubstituted vinyl halide, substituted or unsubstituted vinyl pseudohalide, substituted or unsubstituted allylic alcohol, substituted or unsubstituted allylic ether, substituted or unsubstituted aryl or heteroaryl halide and substituted or unsubstituted aryl or heteroaryl pseudohalide.

In yet another aspect of the method, the coupling partner is selected from a mono-substituted, disubstituted, trisubstituted, or tetrasubstituted alkene, mono-substituted or disubstituted alkyne, substituted or unsubstituted aryl or heteroaryl halide and substituted or unsubstituted aryl or heteroaryl pseudohalide. In another aspect of the method, the mixture provides a medium for transition metal-catalyzed cross-coupling reaction comprising olefin cross-metathesis, ring closing metathesis, Sonogashira coupling, Heck coupling, direct amination of free allylic alcohols, aminations of allylic ethers, C—H activation reactions (e.g., Fujiwara-Moritani couplings, arylations and heteroarylations of aromatic and heteroaromatic rings, etc.), Suzuki-Miyaura coupling, Buchwald-Hartwig amination, Negishi couplings, benzylic couplings (halides, pseudohalides, etc.) with aryl halides or pseudohalides, silylations of allylic ethers, and all types of aryl-aryl (e.g., combinations of aromatic and heteroaromatic) cross-couplings (biaryl formation). In one variation of the above coupling reactions, the transition metal for the metal catalyzed cross-coupling reaction is gold.

In one aspect of the above method, the palladacycle of the formula IVa, IVb, IVc or IVd, or the palladacycle of the formula Va, Vb, Vc or Vd is diastereomerically pure, and the coupling product has a diastereomeric excess greater than 80%, greater than 85%, greater than 90%, greater than 95% or greater than 98%. In certain aspects of the present application, the diastereoselctive reactions yield a coupling product with a d.e. greater than 50%, greater than 60%, greater than 70%, greater than 80%, greater than 90% or greater than 95%.

In another aspect of the method, the reaction is accelerated by increasing the ionic strength of the reaction medium and/or by the increase of reduction of the pH of the reaction mixture. In another aspect of the method, increasing the ionic strength is performed by the addition of a metal salt or mixtures of salts, and/or the pH is reduced to a range of pH 2-6, or increased to a range of 7-11.

The foregoing examples of the related art and limitations are intended to be illustrative and not exclusive. Other limitations of the related art will become apparent to those of skill in the art upon a reading of the specification and a study of the drawings or figures as provided herein.

In addition to the exemplary embodiments, aspects and variations described above, further embodiments, aspects and variations will become apparent by reference to the drawings and figures and by examination of the following descriptions.

### DETAILED DESCRIPTION OF THE INVENTION

### Definitions

Unless specifically noted otherwise herein, the definitions of the terms used are standard definitions used in the art of organic synthesis and pharmaceutical sciences. Exemplary embodiments, aspects and variations are illustratived in the figures and drawings, and it is intended that the embodiments, aspects and variations, and the figures and drawings disclosed herein are to be considered illustrative and not limiting.

An “alkyl” group is a straight, branched, saturated or unsaturated, aliphatic group having a chain of carbon atoms, optionally with oxygen, nitrogen or sulfur atoms inserted between the carbon atoms in the chain or as indicated. A C₁₋₂₀ alkyl, for example, includes linear or branched alkyl groups that have a chain of between 1 and 20 carbon atoms, and include, for example, the groups methyl, ethyl, propyl, isopropyl, vinyl, allyl, 1-propenyl, isopropenyl, ethynyl, 1-propynyl, 2-propynyl, 1,3-butadienyl, penta-1,3-dienyl, penta-1,4-dienyl, hexa-1,3-dienyl, hexa-1,3,5-trienyl, and the like. An alkyl group may also be represented, for example, as a —(CR¹R²)ₘ— group where R¹ and R² are independently hydrogen or are independently absent, and for example, m is 1 to 8, and such representation is also intended to cover both saturated and unsaturated alkyl groups.

An alkyl as noted with another group such as an aryl group, represented as “arylalkyl” for example, is intended to be a straight, branched, saturated or unsaturated aliphatic divalent group with the number of atoms indicated in the alkyl group (as in C₁₋₂₀ alkyl, for example) and/or aryl group (as in C₆₋₁₀aryl or C₅₋₁₄aryl, for example) or when no atoms are indicated means a bond between the aryl and the alkyl group. Nonexclusive examples of such group include benzyl, phenethyl and the like.

An “alkylene” group is a straight, branched, saturated or unsaturated aliphatic divalent group with the number of atoms indicated in the alkyl group; for example, a —C₁₋₃ alkylene- or —C₁₋₃ alkylenyl-.

An “amino” group means a nitrogen moiety having two further substituents where a hydrogen or carbon atom is attached to the nitrogen. Representative amino groups include —NH₂, —NHCH₃, —N(CH₃)₂, —NHC₁₋₃-alkyl, —N(C₁₋₃-alkyl)₂ and the like. Unless indicated otherwise, the compounds of the present application containing amino groups may include protected derivatives thereof. Such protecting groups for amino groups include acetyl, tert-butoxycarbonyl, benzyloxycarbonyl, and the like.

An “AR—” group, “aryl” group or “aromatic” group means a moiety wherein the constituent atoms make up an unsaturated ring system, where all atoms in the ring system are sp² hybridized and the total number of pi electrons is equal to 4n+2. An example of an aryl group may be a C₄₋₁₀ aryl, a C₆ aryl or a C₆₋₁₀ aryl group, or an C₅₋₁₁ heteroaryl group. An aromatic ring may be such that the ring atoms are all carbon atoms or may include carbon and non-carbon atoms. Such rings comprising carbon and non-carbon atoms are also referred to as heteroaryls.

The term “catalytic amount” is known in the art and as used herein, means a sub-stoichiometric amount of reagent relative to a reactant. A catalytic amount means from 0.0001 to 90 mole percent reagent relative to a reactant, such as from 0.001 to 50 mole percent, from 0.01 to 10 mole percent, from 0.1 to 5 mole percent or from 0.1 to 1 mole percent reagent to reactant.

A “cyclyl” group such as a monocyclyl or polycyclyl group includes monocyclic, linearly fused, angularly fused or bridged polycycloalkyl, or combinations thereof. Such cyclyl group is intended to include the heterocyclyl analogs. A cyclyl group may be saturated, partially saturated or aromatic.

The term “enantioselective” or “diastereoselective” reaction described in the present application include reactions which are enantioselective and/or diastereoselective. An enantioselective reaction is a reaction which converts an achiral reactant to a chiral product enriched in one enantiomer. As is known in the art, enantioselectivity is generally quantified as “enantiomeric excess” (e.e.) and may be defined as follows: % Enantiomeric Excess A (ee)=(% Enantiomer A)−(% Enantiomer B) where A and B are the enantiomers formed. Similarly, diastereoselectivity may be quantified as “diastereomeric excess” (d.e.). Alternative terms that may be used in conjunction with enatioselectivity include “optical purity” or “optical activity”. An enantioselective reaction yields a product with an e.e. greater than zero. In certain aspects of the present application, enantioselective reactions yield a product with an e.e. greater than 50%, greater than 60%, greater than 70%, greater than 80%, greater than 90% or greater than 95%. Accordingly, a diastereoselective reaction converts a chiral reactant such as a chiral coupling substrate, a chiral coupling a coupling partner or a chiral palladacycle, or a combination thereof (which may be racemic or enantiomerically pure), to form a chiral coupling product that is enriched in one diastereomer. Accordingly, a diastereoselctive reaction yields a product with an d.e. greater than zero. In certain aspects of the present application, diastereoselctive reactions yield a product with a d.e. greater than 50%, greater than 60%, greater than 70%, greater than 80%, greater than 90% or greater than 95%.

“Halogen” or “halo” means fluorine, chlorine, bromine or iodine.

“Heteroaryl” means a cyclic aromatic group having five or six ring atoms, wherein at least one ring atom is a heteroatom such as N, O and S, and the remaining ring atoms are carbon. The nitrogen atoms can be optionally quaternerized and the sulfur atoms can be optionally oxidized. Heteroaryl groups include, but are not limited to, those derived from furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole. “Heteroaryl” may also include, but is not limited to, bicyclic or tricyclic rings, wherein the heteroaryl ring is fused to one or two rings such as an aryl ring, a cycloalkyl ring, a cycloalkenyl ring and another monocyclic heteroaryl or heterocycloalkyl ring. These bicyclic or tricyclic heteroaryls may include those derived from benzo[b]furan, benzo[b]thiophene, benzimidazole, imidazo[4,5-c]pyridine, quinazoline, thieno[2,3-c]pyridine, thieno[3,2-b]pyridine, thieno[2,3-b]pyridine, indolizine, imidazo[1,2a]pyridine, quinoline, isoquinoline, phthalazine, quinoxaline, naphthyridine, quinolizine, indole, isoindole, indazole, indoline, benzoxazole, benzopyrazole, benzothiazole, imidazo[1,5-a]pyridine, pyrazolo[1,5-a]pyridine, imidazo[1,2-a]pyrimidine, imidazo[1,2-c]pyrimidine, imidazo[1,5-a]pyrimidine, imidazo[1,5-c]pyrimidine, pyrrolo[2,3-b]pyridine, pyrrolo[2,3-c]pyridine, pyrrolo[3,2-c]pyridine, pyrrolo[3,2-b]pyridine, pyrrolo[2,3-d]pyrimidine, pyrrolo[3,2-d]pyrimidine, pyrrolo[2,3-b]pyrazine, pyrazolo[1,5-a]pyridine, pyrrolo[1,2-b]pyridazine, pyrrolo[1,2-c]pyrimidine, pyrrolo[1,2-a]pyrimidine, pyrrolo[1,2-a]pyrazine, triazo[1,5-a]pyridine, pteridine, purine, carbazole, acridine, phenazine, phenothiazene, phenoxazine, 1,2-dihydropyrrolo[3,2,1-hi]indole, indolizine, pyrido[1,2-a]indole and 2(1H)-pyridinone. The heteroaryl groups can be substituted or unsubstituted.

A “heterocyclyl”, “heterocycloalkyl” or “heterocycle” is a cycloalkyl wherein one or more of the atoms forming the ring is a heteroatom that is a N, O, or S. Non-exclusive examples of heterocyclyl include piperidyl, 4-morpholyl, 4-piperazinyl, pyrrolidinyl, 1,4-diazaperhydroepinyl, 1,3-dioxanyl and the like.

“Isomers” mean any compound having an identical molecular formulae but differing in the nature or sequence of bonding of their atoms or in the arrangement of their atoms in space. Isomers that differ in the arrangement of their atoms in space are termed “stereoisomers.” Stereoisomers that are not mirror images of one another are termed “diastereomers” and stereoisomers that are nonsuperimposable mirror images are termed “enantiomers.” A mixture of the two enantiomeric forms is termed a “racemic mixture.” Compounds with more than one chiral center may exist as ether an individual diastereomer or as a mixture of diastereomers, or referred to as a “diastereomeric mixture.” Absolute configuration refers to the arrangement in space of the substituents attached to the chiral center. Enantiomers are characterized by the absolute configuration of their chiral centers and described by the R- and S-sequencing rules of Cahn, Ingold and Prelog. Conventions for stereochemical nomenclature, methods for the determination of stereochemistry and the separation of stereoisomers are well known in the art, and include, for example, “Advanced Organic Chemistry”, 4th edition, March, Jerry, John Wiley & Sons, New York, 1992.

A “perhalo(C₁₋₃)alkyl” group is an alkyl group in which all of the hydrogens are replaced by a halo atom or group, such as F, Cl or Br. Example of such groups include —CF₃, —C₂F₅ and —C₃F₇.

“Substituted or unsubstituted” or “optionally substituted” means that a group such as alkyl, aryl, heterocyclyl, C₁₋₈ cycloalkyl, heterocyclyl(C₁₋₈)alkyl, aryl(C₁₋₈)alkyl, heteroaryl, heteroaryl(C₁₋₈)alkyl, unless specifically noted otherwise, may be unsubstituted or may substituted by 1, 2 or 3 substituents selected from the group such as halo, —CN, —NO₂, trifluoromethyl, trifluoromethoxy, methoxy, —COOH, —NH₂, —OH, —SH, —SMe, —NH(CH₃)₂, —N(CH₃)₂ and the like.

The term “transition metal catalyst” include any catalytic transition metal and/or catalyst precursor as it is introduced into the reaction vessel and which is, as needed, converted in situ into the active form, as well as the active form of the catalyst or combination thereof, which participate in the reaction.

In certain embodiments of the application, the transition metal catalyst complex is provided in the reaction mixture is in a catalytic amount, which may be in the range of 0.0001 to 20 mol %, 0.01 to 10 mol %, 0.05 to 5 mol %, 0.1 to 1 mol %, 1 to 2 mol % or 1 to 4 mol %, with respect to the limiting reagent. Representative limiting reagents, as the coupling partners, may include an aromatic compound, an amine, a boronic acid, a ketone or the like, or salts thereof, depending upon which reaction partner is in stoichiometric excess.

In one aspect, the catalysts employed involve the use of metals which can mediate cross-coupling of any of the common reaction partners in a Suzuuki-Miyaura coupling, such as aryl groups bearing halogens or pseudohalides or diazonium salts. Suitable metals used in the present application include platinum, palladium, gold, iron, nickel, ruthenium, iridium, and rhodium. Typically, the metal core of the catalyst in reactive form may be a zero valent transition metal, such as with Pd or Ni, with the ability to undergo oxidative addition, such as to a Ar—X bond.

In one aspect, the zero-valent state, M(0), may be generated in situ, e.g., from M(II). Suitable soluble palladium complexes include, but are not limited to, tris(dibenzylideneacetone) dipalladium [Pd₂(dba)₃], bis(dibenzylideneacetone) palladium [Pd(dba)₂] and palladium acetate.

In another aspect, the coupling reaction can be catalyzed by a palladium catalyst where palladium may be provided in the form of, for example, Pd/C, PdCl₂, Pd(OAc)₂, (CH₃CN)₂PdCl₂, Pd[P(C₆H₅)₃]₄, and polymer supported Pd(0). In another aspect, the reaction can be catalyzed by a nickel catalyst, such as Ni(acac)₂, NiCl₂[P(C₆H₅)]₂, Ni(1,5-cyclooctadiene)₂, Ni(1,10-phenanthroline)₂, Ni(dppf)₂, NiCl₂(dppf), NiCl₂(1,10-phenanthroline), Raney nickel and the like.

In another aspect, the catalyst may be provided in the reaction mixture as metal-ligand complex comprising a bound supporting ligand, that is, a metal-supporting ligand complex. Where the ligand is a chiral ligand, the ligand may be in the form of a racemic mixture (if applicable) or as a purified stereoisomer such as a pure diastereomer or enantiomer (as mirror images). In another aspect, the catalyst complex may include additional supporting ligands. The ligand can be added to the reaction mixture in the form of a metal complex, or added as a separate reagent relative to the addition of the metal.

Representative ligands provided in the present application include the following compounds of the formulae Ia, Ib, Ic or Id, in Tables 1 and 2:

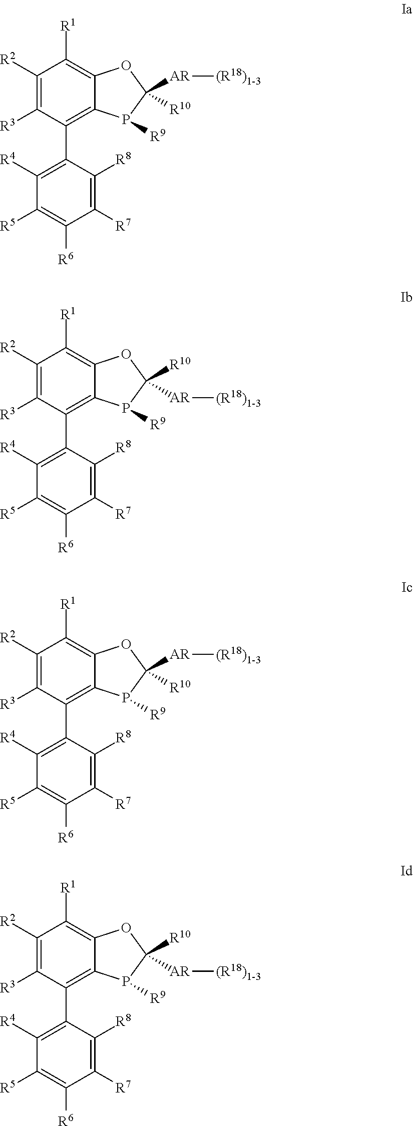

TABLE 1

| | Compounds | | | | | | | | | |
|---|---|---|---|---|---|---|---|---|---|---|
| Group | 20 | 21 | 22 | 23 | 24 | 25 | 26 | 27 | 28 | 29 |
| AR- | Phe | Phe | Phe | Phe | Phe | Phe | Phe | Phe | Phe | Phe |
| R¹ | H | H | H | H | H | H | H | H | H | H |
| R² | H | H | H | H | H | H | H | H | H | H |
| R³ | H | H | H | H | H | H | H | H | H | H |
| R⁴ | —OMe | —OMe | —OMe | —OMe | —OMe | Me | Me | Me | Me | Me |
| R⁵ | H | H | H | H | H | H | H | H | H | H |
| R⁶ | H | H | H | H | H | H | H | H | H | H |
| R⁷ | H | H | H | H | H | H | H | H | H | H |
| R⁸ | —OMe | —OMe | —OMe | —OMe | —OMe | Me | Me | Me | Me | Me |
| R⁹ | Me | i-Pro | t-But | c-Hex | Phe | 1-Ada | o-tol | p-tol | o-anis | 3,5- |
| | | | | | | | | | | dm- |
| | | | | | | | | | | Phe |
| R¹⁰ | H | H | H | H | H | H | H | H | H | H |
| R¹⁸ | 2,4,6-i- | 2,4,6- | 2,4,6- | 2,4,6- | 2,4,6- | 2,4,6- | 2,4,6- | 2,4,6- | 2,4,6- | 2,4,6-i- |
| | Pro | i-Pro | i-Pro | i-Pro | i-Pro | i-Pro | i-Pro | i-Pro | i-Pro | Pro |

TABLE 2

| | Compounds | | | | | | | | | |
|---|---|---|---|---|---|---|---|---|---|---|
| Group | 30 | 31 | 32 | 33 | 34 | 35 | 36 | 37 | 38 | 39 |
| AR- | Phe | Phe | Phe | Phe | Phe | Phe | Phe | Phe | Phe | Phe |
| R¹ | H | H | H | H | H | H | H | H | H | H |
| R² | H | H | H | H | H | H | H | H | H | H |
| R³ | H | H | H | H | H | H | H | H | H | H |
| R⁴ | —OMe | —OMe | —OMe | —OMe | —OMe | —OMe | —OMe | i-Pr | i-Pr | i-Pr |
| R⁵ | H | H | H | H | H | H | H | H | H | H |
| R⁶ | H | H | H | H | H | H | H | H | H | H |
| R⁷ | H | H | H | H | H | H | H | H | H | H |
| R⁸ | —OMe | —OMe | —OMe | —OMe | —OMe | —OMe | —OMe | i-Pr | i-Pr | i-Pr |
| R⁹ | Me | i-Pro | t-Bu | c-Hex | Phe | 1-Ada | o-tol | p-tol | o-anis | 3,5- |
| | | | | | | | | | | dm- |
| | | | | | | | | | | Phe |
| R¹⁰ | H | H | H | H | H | H | H | H | H | H |
| R¹⁸ | 2,4,6-i- | 2,4,6- | 2,4,6- | 2,4,6- | 2,4,6- | 2,4,6- | 2,4,6- | 2,4,6- | 2,4,6- | 2,4,6-i- |
| | Pro | i-Pro | i-Pro | i-Pro | i-Pro | i-Pro | i-Pro | i-Pro | i-Pro | Pro |

Abbreviation:
Phe = phenyl;
i-Pro = isopropyl;
t-But = tert-butyl;
c-Hex = cyclohexyl;
1-Ada = 1-adamantyl;
o-tol. = ortho-toluenyl;
p-tol = para-toluenyl;
o-anis = ortho-anisyl;
Naph = naphthyl;
3,5-dm-Phe = 3,5-dimethylphenyl;
2,4,6-i-Pro = 2,4,6-tri-isopropyl;
—OTs = —O-4-toluenesulfonyl;
—OMs = —O-methanesulfonyl.

Representative palladacycles of the present application include the compounds of the formula IVa, IVb, IVc or IVd, in Tables 3 and 4:

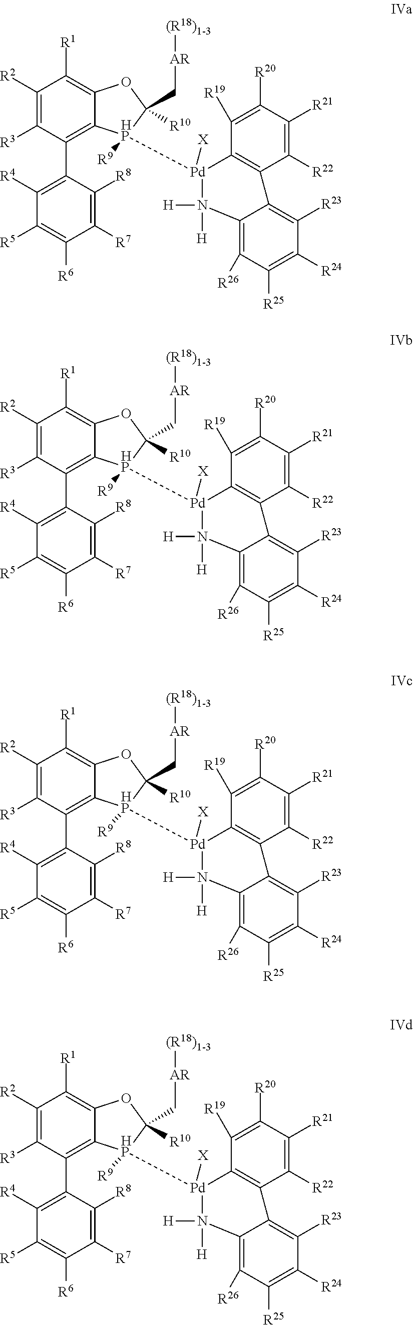

TABLE 3

| | Compounds | | | | | | | | | |
|---|---|---|---|---|---|---|---|---|---|---|
| Group | 40 | 41 | 42 | 43 | 44 | 45 | 46 | 47 | 48 | 49 |
| AR- | Phe | Phe | Phe | Phe | Phe | Phe | Phe | Phe | Phe | Phe |
| X | Cl | CL | Cl | Cl | Cl | Cl | Cl | Cl | Cl | Cl |
| R¹ | H | H | H | H | H | H | H | H | H | H |
| R² | H | H | H | H | H | H | H | H | H | H |
| R³ | H | H | H | H | H | H | H | H | H | H |
| R⁴ | —OMe | —OMe | —OMe | —OMe | —OMe | —OMe | i-Pr | i-Pr | i-Pr | i-Pr |
| R⁵ | H | H | H | H | H | H | H | H | H | H |
| R⁶ | H | H | H | H | H | H | H | H | H | H |
| R⁷ | H | H | H | H | H | H | H | H | H | H |
| R⁸ | —OMe | —OMe | —OMe | —OMe | —OMe | —OMe | i-Pr | i-Pr | i-Pr | i-Pr |
| R⁹ | Me | i-Pro | t-But | c-Hex | Phe | 1-Ada | o-tol | p-tol | o-anis | 3,5- |
| | | | | | | | | | | dm- |
| | | | | | | | | | | Phe |
| R¹⁰ | H | H | H | H | H | H | H | H | H | H |
| R¹⁸ | 2,4,6-i- | 2,4,6- | 2,4,6- | 2,4,6- | 2,4,6- | 2,4,6- | 2,4,6- | 2,4,6- | 2,4,6- | 2,4,6- |
| | Pro | i-Pro | i-Pro | i-Pro | i-Pro | i-Pro | i-Pro | i-Pro | i-Pro | i-Pro |
| R¹⁹ | H | H | H | H | H | H | H | H | H | H |
| R²⁰ | H | H | H | H | H | H | H | H | H | H |
| R²¹ | H | H | H | H | H | H | H | H | H | H |
| R²² | H | H | H | H | H | H | H | H | H | H |
| R²³ | H | H | H | H | H | H | H | H | H | H |
| R²⁴ | H | H | H | H | H | H | H | H | H | H |
| R²⁵ | t-Bu | t-Bu | t-Bu | t-Bu | t-Bu | t-Bu | i-Pro | i-Pro | i-Pro | i-Pro |
| R²⁶ | H | H | H | H | H | H | H | H | H | H |

TABLE 4

| | Compounds | | | | | | | | | |
|---|---|---|---|---|---|---|---|---|---|---|
| Group | 50 | 51 | 52 | 53 | 54 | 55 | 56 | 57 | 58 | 59 |
| AR- | Phe | Phe | Phe | Phe | Phe | Phe | Phe | Phe | Phe | Phe |
| X | Cl | CL | Cl | Cl | Cl | —OMs | —OMs | —OMs | —OTs | —OTs |
| R¹ | H | H | H | H | H | H | H | H | H | H |
| R² | H | H | H | H | H | H | H | H | H | H |
| R³ | H | H | H | H | H | H | H | H | H | H |
| R⁴ | —OMe | —OMe | —OMe | —OMe | —OMe | —OMe | i-Pr | i-Pr | i-Pr | i-Pr |
| R⁵ | H | H | H | H | H | H | H | H | H | H |
| R⁶ | H | H | H | H | H | H | H | H | H | H |
| R⁷ | H | H | H | H | H | H | H | H | H | H |
| R⁸ | —OMe | —OMe | —OMe | —OMe | —OMe | —OMe | i-Pr | i-Pr | i-Pr | i-Pr |
| R⁹ | Me | i-Pro | t-Bu | c-Hex | Phe | 1-Ada | o-tol | p-tol | o-anis | 3,5- |
| | | | | | | | | | | dm- |
| | | | | | | | | | | Phe |
| R¹⁰ | H | H | H | H | H | H | H | H | H | H |
| R¹⁸ | 2,4,6-i- | 2,4,6- | 2,4,6- | 2,4,6- | 2,4,6- | 2,4,6- | 2,4,6- | 2,4,6- | 2,4,6- | 2,4,6- |
| | Pro | i-Pro | i-Pro | i-Pro | i-Pro | i-Pro | i-Pro | i-Pro | i-Pro | i-Pro |
| R¹⁹ | H | H | H | H | H | H | H | H | H | H |
| R²⁰ | H | H | H | H | H | H | H | H | H | H |
| R²¹ | H | H | H | H | H | H | H | H | H | H |
| R²² | H | H | H | H | H | H | H | H | H | H |
| R²³ | H | H | H | H | H | H | H | H | H | H |
| R²⁴ | H | H | H | H | H | H | H | H | H | H |
| R²⁵ | t-Bu | t-Bu | t-Bu | t-Bu | t-Bu | t-Bu | i-Pro | i-Pro | i-Pro | i-Pro |
| R²⁶ | H | H | H | H | H | H | H | H | H | H |

Abbreviation:
Phe = phenyl;
i-Pro = isopropyl;
t-But = tert-butyl;
c-Hex = cyclohexyl;
1-Ada = 1-adamantyl;
o-tol = ortho-toluenyl;
p-tol. = para-toluenyl;
o-anis = ortho-anisyl;
Naph = naphthyl;
3,5-dm-Phe = 3,5-dimethylphenyl;
2,4,6-i-Pro = 2,4,6-tri-isopropyl;
—OTs = —O-4-toluenesulfonyl;
—OMs = —O-methanesulfonyl.

### EXPERIMENTAL

### Synthesis of Ligands and Palladacycles:

The following procedures may be employed for the preparation of the compounds of the present invention. The starting materials and reagents used in preparing these compounds are either available from commercial suppliers such as the Aldrich Chemical Company (Milwaukee, Wis.), Bachem (Torrance, Calif.), Sigma (St. Louis, Mo.), or are prepared by methods well known to a person of ordinary skill in the art, following procedures described in such references as Fieser and Fieser's Reagents for Organic Synthesis, vols. 1-17, John Wiley and Sons, New York, N.Y., 1991; Rodd's Chemistry of Carbon Compounds, vols. 1-5 and supps., Elsevier Science Publishers, 1989; Organic Reactions, vols. 1-40, John Wiley and Sons, New York, N.Y., 1991; March J.: Advanced Organic Chemistry, 4th ed., John Wiley and Sons, New York, N.Y.; and Larock: Comprehensive Organic Transformations, VCH Publishers, New York, 1989.

In some cases, protective groups may be introduced and finally removed. Suitable protective groups for amino, hydroxy and carboxy groups are described in Greene et al., Protective Groups in Organic Synthesis, Second Edition, John Wiley and Sons, New York, 1991. Standard organic chemical reactions can be achieved by using a number of different reagents, for examples, as described in Larock: Comprehensive Organic Transformations, VCH Publishers, New York, 1989.

In one variation, the ligands of this application can be prepared by the steps outlined in the Scheme below, as exemplified for the preparation of HandaPhos, 8:

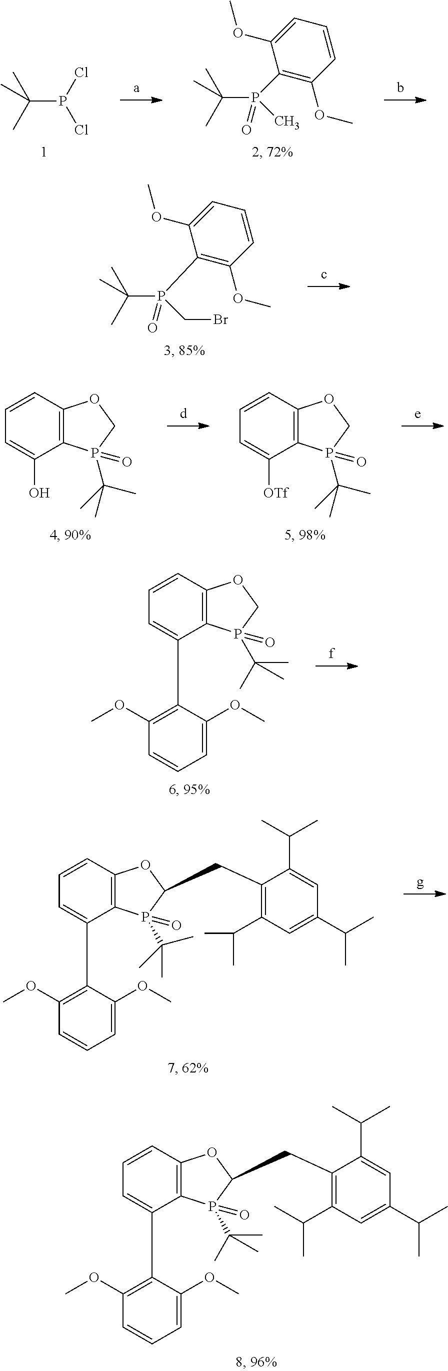

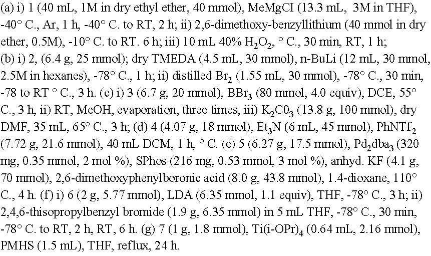

### t-Butyl-(2,6-dimethoxyphenyl)(methyl)phosphine oxide, 2

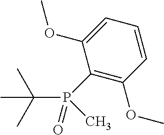 [SMILES: COc1cccc(OC)c1P(C)(=O)C(C)(C)C]

To an oven dried 500 mL two-neck round-bottomed flask containing a magnetic stirrer bar and equipped with a condenser containing argon inlet and a rubber septum, a solution of t-butyldichlorophosphine 1 (40 mL, 1 M in ethyl ether, 40 mmol) was added via syringe. The reaction mixture was cooled to −40° C. using an acetonitrile-dry ice slurry. To the cold solution of 1, MeMgCl (13.3 mL, 3 M in THF, 40 mmol) was added drop-wise via syringe while maintaining the reaction temperature constant. After complete addition of the Grignard reagent, the reaction mixture was stirred for 1 h at −40° C., after which it was slowly warmed to RT over 2 h, and stirred for an additional hour at RT.

After stirring the reaction mixture for an hour at RT, it was re-cooled to −10° C. using an ice/NaCl slurry. To the cold reaction mixture, a lithiated solution of 1,3-dimethoxybenzene (prepared by the procedure as given in the next paragraph) was slowly added via cannula. The reaction mixture was allowed to come to RT, and stirred for an additional 6 h at RT. The mixture was cooled to 0° C., and a 40% aqueous solution of H₂O₂ (10 mL) was slowly added with caution. During addition of H₂O₂, a vigorous effervescence was observed. After complete addition of H₂O₂, the mixture was stirred at RT for 1 h. The THF was then evaporated, and the mixture extracted with DCM (4×50 mL).

The combined organic layer was dried over anhydrous MgSO₄, and the volatiles were evaporated under reduce pressure to obtain crude product as a viscous oil. The material was purified by flash chromatography over silica gel using EtOAc/methanol (7:3) as eluent to obtain pure product as a white solid (7.28 g, 72%). While keeping the crude material for a long time over silica gel (>0.6 h), decomposition/polymerization of desired material was observed. ¹H NMR (500 MHz, CDCl₃) δ 7.42 (m, 1H), 6.60 (dd, J=8.4, 3.8 Hz, 2H), 3.83 (s, 6H), 1.83 (d, J=13.2 Hz, 3H), 1.19 (d, J=15.4 Hz, 9H); ³¹P NMR (162 MHz, CDCl₃) δ 51.6; ¹³C NMR (125 MHz, CDCl₃) δ 163.2 (d, J=1.0 Hz), 133.7 (d, J=1.0 Hz), 107.4 (d, J=82 Hz), 104.5 (d, J=6 Hz), 55.6, 34.6 (d, J=72 Hz), 24.4 (d, J=1.6 Hz), and 15.8 (d, J=69 Hz).

A solution of lithium 1,3-dimethoxybenzene was prepared as follows. Under an inert argon atmosphere, to a solution of 1,3-dimethoxybenzene (5.24 mL, 40 mmol) in dry THF (10 mL), a solution of n-BuLi (16 mL, 2.5 M in hexanes, 40 mmol) was slowly added via syringe at −5° C. The reaction mixture was stirred for 30 min at −5° C. The appearance of a slightly yellow color of a reaction mixture was indicative of the desired lithiation. Caution: Temperature of the reaction mixture must be maintained (−5° C.) throughout the reaction).

### (Bromomethyl)(t-butyl)(2,6-dimethoxyphenyl)phosphine oxide, 3

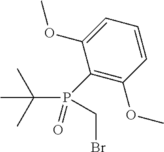 [SMILES: COc1cccc(OC)c1P(=O)(CBr)C(C)(C)C]

To an oven dried, 250 mL two-neck round-bottomed flask containing a magnetic stirrer bar and equipped with an argon inlet and rubber septum, a solution of 2 (6.4 g, 25 mmol) in 25 mL dry THF was transferred via syringe. The reaction mixture was cooled to −78° C., and TMEDA (4.5 mL, 30 mmol) was added. While maintaining a reaction temperature constant to −78° C., a solution of 2.5 M n-BuLi in hexanes (12 mL, 30 mmol) was slowly added via syringe. The mixture was stirred at −78° C. for 1 h. HBr-free distilled Br₂ (1.55 mL, 30 mmol) was added to the reaction mixture, after which it was stirred for 30 min at −78° C. The mixture was then allowed to come to RT over the period of 2 h, and stirred for an additional 30 min at RT.

The mixture was quenched with 1 M solution of Na₂SO₃ (10 mL). THF was then evaporated under reduce pressure, and the mixture extracted with DCM (3×30 mL). The combined organic extracts were dried over anhydrous magnesium sulfate, and the volatiles were removed under reduced pressure to obtain crude product as a viscous oil. The crude product was purified by flash chromatography over silica gel using EtOAc/MeOH as eluent (9/1). Pure product was obtained as viscous oil which solidified over time (7.12 g, 85%). ¹H NMR (500 MHz, CDCl₃) δ 7.41 (t, J=8.4 Hz, 1H), 6.57 (dd, J=8.4, 4.0 Hz, 2H), 3.81 (s, 6H), 3.79 (m, 1H), 3.34 (dd, J=11.2, 8.3 Hz, 1H), 1.18 (d, J=15.6 Hz, 9H); ³¹P NMR (162 MHz, CDCl₃) δ 50.3; ¹³C NMR (125 MHz, CDCl₃): δ=163.2, 134.2, 104.8 (d, J=63 Hz), 104.4 (d, J=6 Hz), 55.9, 35.3 (d, J=71 Hz), 25.0, -1.8 (d, J=59 Hz.

### 3-(t-Butyl)-4-hydroxy-2,3-dihydrobenzo[d][1,3]oxaphosphole-3-oxide, 4

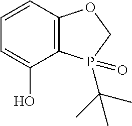

Under an argon atmosphere, in a two-necked round-bottomed flask, 3 (6.7 g, 20 mmol) was dissolved in 30 mL dry DCE. A condenser containing an argon inlet was added onto the round-bottomed flask. A 1 M solution of BBr₃ in CH₂Cl₂ (80 mL, 80 mmol) was added to the reaction mixture via syringe. The mixture was refluxed at 55° C. for 3 h, after which it was cooled to RT, and argon was then bubbled through it. Methanol (10 mL) was then slowly added to the reaction mixture. Solvent was removed under reduced pressure to obtain a mixture as viscous oil. Methanol (30 mL) was added to the viscous oil, and the volatiles were evaporated under reduced pressure. Addition of methanol (3×30 mL) followed by evaporation under reduced pressure was repeated at three to four times. The resulting viscous oil was evacuated under reduced pressure for 2 h.

The viscous oil from above was dissolved in dry DMF (30 mL), and dry K₂CO₃ (13.8 g, 100 mmol) was added. The reaction mixture was stirred at 65° C. for 3 h, after which it was cooled to RT and then filtered through a frit. The remaining K₂CO₃ cake was washed with an additional 50 mL of 10% MeOH/DCM. The volatiles were then removed under reduced pressure from the combined organic layer containing DMF, MeOH and DCM. Crude product was obtained as a sticky solid, which was triturated with diethyl ether (10 mL) to obtain pure product as a white solid. ¹H NMR (500 MHz, CD₃OD) δ 7.34 (t, J=8.2 Hz, 1H), 6.46 (m, 2H), 4.72 (dd, J=14.3, 3.3 Hz, 1H), 4.31 (dd, J=14.3, 10.7 Hz, 1H), 1.28 (d, J=16.6 Hz, 9H); ³¹P NMR (162 MHz, CDCl₃) δ=68.7; ¹³C NMR (125 MHz, CD₃OD) δ 168.5 (d, J=17.2 Hz), 161.5 (d, J=2.2 Hz), 138.4, 109.1 (d, J=6.1 Hz), 105.5 (d, J=5.4 Hz), 101.7 (d, J=94.3 Hz), 67.0 (d, J=61 Hz), 34.6 (d, J=74 Hz), 24.9.

### 3-(t-Butyl)-3-oxido-2,3-dihydrobenzo[d][1,3]oxaphosphol-4-yl trifluoromethansulfonate, 5

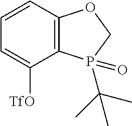 [SMILES: CC(C)(C)P1(=O)COc2cccc(OS(=O)(=O)C(F)(F)F)c21]

The phosphine oxide from above (4, 4.07, 18 mmol) was added to a 250 mL two-necked round-bottomed flask containing a magnetic stir bar and septa were placed onto each neck. Each septum was closed and an argon balloon was added through the septum with a needle. Dry DCM (60 mL) was added to the reaction mixture via syringe. To the resulting suspension, Et₃N (6 mL, 45 mmol) was added, and reaction mixture was stirred for 10 min at RT, resulting in a clear solution. The reaction mixture was then cooled to 0° C., and a solution of PhNTf₂ (7.72 g, 21.6 mmol) in DCM was slowly added via syringe over a period of 5 min.

The mixture was stirred for 1 h at RT. After complete conversion of starting material as monitored by TLC (usually ca. 1 h), the mixture was washed with water. The organic layer was dried over anhydrous MgSO₄, and volatiles removed under reduced pressure to obtain crude product as a viscous oil. Crude product was purified by column chromatography over silica gel using EtOAc/hexanes as eluent (1/9, 7/3). Pure product was obtained as a white solid (6.32 g, 98%). ¹H NMR (500 MHz, CD₂Cl₂) δ 7.57 (t, J=8.3 Hz, 1H), 7.04 (dd, J=8.2, 3.5 Hz, 1H), 7.01 (dd, J=8.5, 2.4 Hz, 1H), 4.68 (dd, J=14.2, 2.1 Hz, 1H), 4.46 (dd, J=14.1, 11.1 Hz, 1H), 1.21 (d, J=16.8 Hz, 9H); ³¹P NMR (162 MHz, CD₂Cl₂) δ 75.7; ¹³C NMR (125 MHz, CD₂Cl₂) δ=167.1 (d, J=16.8 Hz), 150.1, 137.1, 120.3, 117.9, 114.7 (d, J=4.4 Hz), 114.3 (d, J=4.3 Hz), 66.9 (d, J=59.3 Hz), 34.7 (d, J=72.0 Hz), 24.2.

### 3-(t-Butyl)-4-(2,6-dimethoxyphenyl)-2,3-dihydrobenzo[d][1,3]oxaphosphole-3-oxide, 6

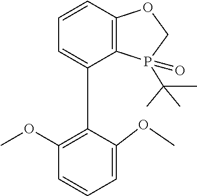 [SMILES: COc1cccc(OC)c1-c1cccc2c1P(=O)(C(C)(C)C)CO2]

Under argon, Pd₂dba₃ (320 mg, 0.35 mmol) and SPhos (216 mg, 0.53 mmol) was added to a sealable reaction vessel. Dry 1,4-dioxane (5.0 mL) was added to the reaction vessel which was then sealed, and the mixture was heated at 85° C. for 5 min. The vessel was lifted from the pre-heated oil bath, and an argon supply was connected via an adapter. The vessel was opened under a positive flow of argon, and 5 (6.27 g, 17.5 mmol), anhydrous KF (4.1 g, 70 mmol) and 2,6-dimethoxyphenylboronic acid (8.0 g, 43.8 mmol) were sequentially added to the reaction mixture.

The mixture was diluted with 40 mL dry 1,4-dioxane, and then re-sealed. The mixture was heated at 110° C. for 3-4 h after which it was cooled to RT and the dioxane evaporated under reduced pressure to obtain slurry of crude product as a brown oil.

The oil was dissolved in 100 ml DCM, and the mixture carefully washed with 1.0 M aq. NaOH and then water. The organic layer was separated, dried over anhydrous MgSO₄, and the solvent was removed under reduced pressure to obtain crude product as a viscous oil. Purification by column chromatography over silica gel using EtOAc/hexanes as eluent (2/3, 4/1) afforded pure product as a white solid (5.76 g, 95%). ¹H NMR (500 MHz, CDCl₃): δ 7.47 (t, J=8.0 Hz, 1H), 7.28 (t, J=8.4 Hz, 1H), 6.89 (m, 2H), 6.64 (d, J=8.4 Hz, 1H), 6.54 (d, J=8.4 Hz, 1H), 4.47 (dd, J=13.8, 2.0 Hz, 1H), 4.34 (dd, J=13.7, 10.5 Hz, 1H), 3.78 (s, 3H), 3.71 (s, 3H), 0.88 (d, J=15.9 Hz, 9H); ³¹P NMR (162 MHz, CDCl₃): δ 62.6; ¹³C NMR (101 MHz, CDCl3): δ=165.3 (d, J=18.8 Hz), 158.6, 157.2, 138.1 (d, J=6.3 Hz), 134.1 (d, J=1.3 Hz), 129.8, 125.1 (d, J=8.8 Hz), 117.4 (d, J=2.5 Hz), 114.8, 114.0, 112.4 (d, J=5.0 Hz), 104.3, 103.2, 65.4 (d, J=60.0 Hz), 55.8, 55.3, 33.5 (d, J=71.3 Hz), 23.6 (d, J=1.3 Hz).

### 3-(t-Butyl)-4-(2,6-dimethoxyphenyl)-2-(2,4,6-triisopropylbenzyl)-2,3 dihydrobenzo[d][1,3]oxaphosphole 3-oxide, 7

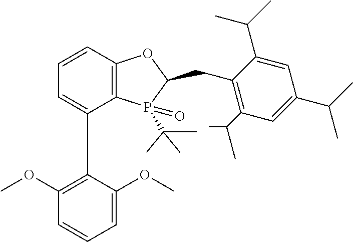 [SMILES: COc1cccc(OC)c1-c1cccc2c1[P@@](=O)(C(C)(C)C)[C@H](Cc1c(C(C)C)cc(C(C)C)cc1C(C)C)O2]

In an oven dried 100 mL two-necked round-bottomed flask equipped with an adapter for an argon inlet and a rubber septum, dry THF (25 mL) was added. DIM (0.9 mL, 6.35 mmol) was added to the reaction mixture, and the mixture was cooled to −78° C. Via syringe, n-BuLi (2.6 mL, 6.36 mmol, 2.5 M in hexanes) was slowly added, and the mixture was stirred for 20 min at −78° C., after which it was allowed to come to room temperature over a period of 30 min and then stirred at RT overnight. This led to formation of LDA for the subsequent reaction.

To a separate 200 mL two-necked round-bottomed flask with an argon inlet and already containing a solution of 6 (2.0 g, 5.77 mmol) in dry THF (50 mL) at −78° C., a solution of LDA as prepared above was slowly added over a period of 30 min. (While adding LDA to the reaction mixture, the temperature must be strictly maintained at −78° C.). The reaction mixture was stirred for 2.5 h at −78° C., resulting in a deep yellow coloration.

After 2.5 h, while maintaining a reaction temperature at −78° C., a solution of 2,4,6-trisopropylbenzyl bromide (1.9 g, 6.35 mmol, in 20 mL THF) was slowly added to a reaction mixture over a period of 1 h. The mixture was stirred for an additional 2 h at −78° C. followed by warming to RT over a period of 1 h.

The reaction mixture was quenched with 1 M NH₄Cl (3 mL). The THF was then evaporated under reduced pressure, and the reaction mixture was extracted with DCM (3×40 mL)/water. Crude product was obtained as a yellow semi-solid which was further purified by flash chromatography over silica gel using EtOAc/hexanes as eluent (1/9, 1/4). Pure product was obtained as a white solid (2.2 g, 62%). ¹H NMR (500 MHz, CDCl₃) δ 7.50 (t, J=8.0 Hz, 1H), 7.32 (t, J=8.0 Hz, 1H), 7.04 (s, 2H), 6.94 (dd, J=7.5, 3.5 Hz, 1H), 6.84 (dd, J=7.5, 3.5 Hz, 1H), 6.68 (d, J=8.0 Hz, 1H), 6.58 (d, J=8.5 Hz, 1H), 4.50-4.46 (m, 1H), 3.83 (s, 3H), 3.73 (s, 3H), 3.28-3.26 (m, 2H), 3.18 (septet, J=7.0 Hz, 2H), 2.89 (septet, J=7.0 Hz, 1H), 1.29-1.26 (m, 12H), 1.21 (d, J=7.0 Hz, 6H), and 0.88 (d, J=16.0 Hz, 9H); ³¹P NMR (162 MHz, CD₂Cl₂) δ 59.7; ¹³C NMR (126 MHz, CD₂Cl₂) δ 163.5 (d, J=19.9 Hz), 158.9, 157.5, 147.5, 147.2, 138.7 (d, J=5.0 Hz), 134.4, 130.0, 129.5 (d, J=10.6 Hz), 125.0 (d, J=8.3 Hz), 121.4, 117.5, 114.6, 113.9, 112.7, 112.7, 104.7, 103.2, 75.9 (d, J=59.1 Hz), 56.4, 55.6, 34.3, 33.6 (d, J=70.6 Hz), 29.5, 27.0, 24.8, 24.3, 24.2 (d, J=9.7 Hz), and 23.7. HRMS calcd. (m/z) 562.3212, found (M⁺) 562.3216.

### 3-(t-Butyl)-4-(2,6-dimethoxyphenyl)-2-(2,4,6-triisopropylbenzyl)-2,3 dihydrobenzo[d][1,3]oxaphosphole, 8

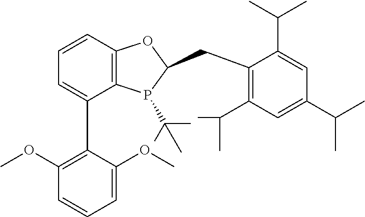 [SMILES: COc1cccc(OC)c1-c1cccc2c1[P@@](C(C)(C)C)[C@H](Cc1c(C(C)C)cc(C(C)C)cc1C(C)C)O2]

In a two-necked round-bottomed flask equipped with a condenser containing an argon inlet and a septum, a solution of 7 (1.0 g, 1.8 mmol, in 20 mL dry THF) was added via syringe. Ti(i-OPr)₄ (0.64 mL, 2.16 mmol) and PMHS (1.5 mL) were sequentially added, and the reaction mixture was refluxed for 24 h under argon. Progress of the reaction was monitored by TLC (EtOAc/hexanes 2/3, R_{f (SM)}=0.45, ether/hexanes 1/9; R_{f (product)}=0.40). After complete consumption of starting material, the mixture was cooled to 0° C., and the argon inlet was removed from the top of the condenser, leaving it open to air. Aqueous NaOH (3 mL, 3 M) solution was added dropwise very cautiously to the reaction mixture. This addition of NaOH caused evolution of hydrogen gas by quenching of unused PMHS. Addition of NaOH solution was stopped after full quenching of PMHS. The mixture was allowed to reach RT over a ca. 1 h period.

The reaction mixture was then filtered through a Celite pad using an additional ethyl ether (25 mL). The combined organic extracts were dried over anhydrous MgSO₄, and solvent was evaporated under reduced pressure to obtain crude product as a semi-solid material. The crude product was purified by flash chromatography over neutral alumina using ether/hexanes as eluent (1/9). Pure product was obtained as a crystalline white solid (0.94 g, 96%). ¹H NMR (400 MHz, CDCl₃) δ 7.35 (t, J=8.0 Hz, 1H), 7.30 (t, J=8.0 Hz, 1H), 7.02 (s, 2H), 6.89 (dd, J=7.2, 2.8 Hz, 1H), 6.85 (d, J=8.0 Hz, 1H), 6.67 (d, J=8.4 Hz, 1H), 6.61 (d, J=8.4 Hz, 1H), 4.89 (dd, J=10.8, 2.8 Hz, 1H), 3.80 (s, 3H), 3.73 (s, 3H), 3.22-3.11 (m, 3H), 2.99-2.84 (m, 2H), 1.28-1.25 (m, 12H), 1.20 (d, J=6.8 Hz, 6H), and 0.71 (d, J=8.0 Hz, 12H); ³¹P NMR (162 MHz, CD₃Cl) δ 9.47; ¹³C NMR (101 MHz, CD₃Cl) δ=163.0, 15.9, 157.2, 147.1 (d, J=34.5 Hz), 138.8 (d, J=16.9 Hz), 130.7, 130.6 (d, J=14.5 Hz), 129.2, 124.8 (d, J=14.9 Hz), 123.8 (d, J=4.1 Hz), 121.2, 119.9, 110.2, 104.7, 103.8, 85.1 (d, J=27.2 Hz), 56.2, 55.6, 34.3, 33.6 (d, J=32.5 Hz), 31.2 (d, J=18.8 Hz), 29.5, 26.7 (d, J=14.5 Hz), 24.8, 24.3, and 24.2. HRMS cald. (m/z) 546.3263, found (M⁺) 546.3255.

### General Procedure for Synthesis of a HandaPhos-Containing Palladacycle

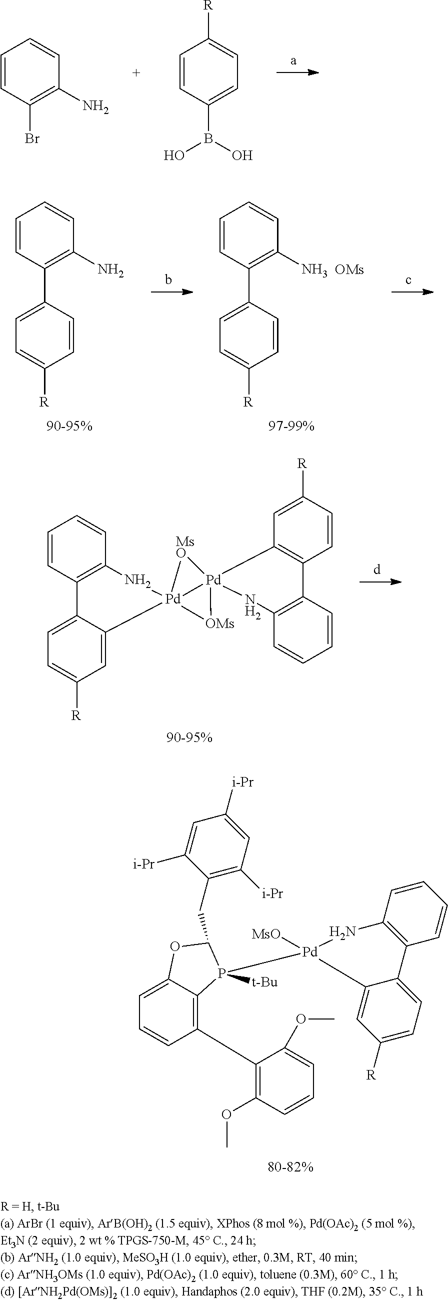

### 4′-(t-Butyl)-[1,1′-iphenyl]-2-amine, 9

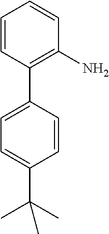 [SMILES: CC(C)(C)c1ccc(-c2ccccc2N)cc1]

In a two-necked round bottomed flask equipped with a septum, 2-bromoaniline (3.0 g, 17.44 mmol), 4-t-butylphenylboronic acid (4.65 g, 26.2 mmol), Pd(OAc)₂ (196 mg, 0.872 mmol), XPhos (665 mg, 1.39 mmol), and Et₃N (4.9 ml, 34.8 mmol) were sequentially added. The reaction vessel was closed, and the mixture degassed with argon. A degassed solution (35 mL) of 2 wt % TPGS-750-M was added to the reaction mixture, and mixture was stirred at 45° C. for 24 h. After complete consumption of starting material as monitored by TLC (10% ether/hexanes, R_{f}=0.45), reaction mixture was allowed to cool to RT.

It was then diluted with 10 mL EtOAc, and stirred for 2-3 min. The organic layer was separated and the aqueous layer was again extracted with an additional 10 mL EtOAc. The combined organic layer was dried over anhydrous MgSO₄, and the volatiles were evaporated under reduced pressure to obtain crude product as a yellow solid. Purification was performed by flash chromatography over silica gel using ether/hexanes as eluent (1/99, 1/19). Pure product was obtained as white solid, 3.7 g (95%), mp 81° C. ¹H NMR (400 MHz, CDCl₃) δ 7.46-7.38 (m, 4H), 7.17 (m, 2H), 6.87 (m, 2H), 4.45 (br s, 2H), 1.35 (s, 9H); ¹³C NMR (101 MHz, CDCl₃) δ 149.95, 143.38, 136.39, 130.43, 128.66, 128.22, 127.65, 125.64, 118.68, 115.60, 34.55, and 31.36.

### [1,1′-Biphenyl]-2-amine, 10

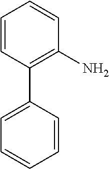 [SMILES: Nc1ccccc1-c1ccccc1]

This compound was synthesized by a procedure similar to the synthesis of 4′-(t-butyl)-[1,1′-biphenyl]-2-amine, above. ¹H NMR (400 MHz, CDCl₃) δ 7.49-7.44 (m, 4H), 7.38-7.35 (m, 1H), 7.19-7.14 (m, 2H), 6.85 (t, J=8.0 Hz, 1H), 6.78 (d, J=8.0 Hz, 1H), 3.76 (br. s, 2H).

### 2-Ammoniumbiphenyl mesylate, 11

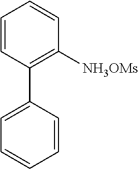

In a two-necked round-bottomed flask, 2-aminobiphenyl (1.26 g, 7.5 mmol) was dissolved in 35 mL of anhydrous diethyl ether. A solution of methanesulfonic acid (0.49 mL, 7.5 mmol) in diethyl ether (5 mL) was slowly added to the reaction mixture, which was stirred at RT for an additional 30 min. Appearance of white solid suspension in the reaction mixture was indicative of salt formation. The solids were filtered through a frit using an additional 40 mL ether. The solid material was dried under reduced pressure to obtain pure compound as a white solid, 1.97 g (98%). ¹H NMR (400 MHz, CD₃OD) δ 7.65-7.41 (m, 9H), 4.92 (s, 2H), 2.67 (s, 3H); ¹³C NMR (101 MHz, CD₃OD) δ 137.4, 136.5, 131.9, 129.5, 129.2, 129.1, 129.0, 128.7, 127.9, 124.0, and 38.4.

### 2-Ammonium-4′-(t-butyl)-[1,1′-biphenyl], 12

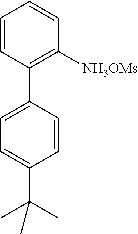

This compound was synthesized by a procedure similar to the synthesis of 2-ammoniumbiphenyl mesylate, above. ¹H NMR (400 MHz, d₆-DMSO) δ 7.56-7.54 (m, 2H), 7.45-7.38 (m, 6H), 2.34 (s, 3H), 1.33 (s, 9H); ¹³C NMR (101 MHz, d₆-DMSO) δ 150.5, 134.9, 133.9, 131.4, 130.5, 128.7, 128.7, 127.5, 125.7, 123.2, 36.5, 34.4, and 31.1.

μ-OMs Dimer of 2-ammoniumbiphenyl mesylate, 13:

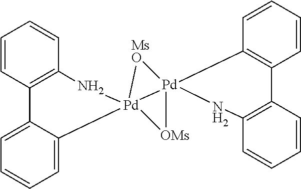

2-Ammoniumbiphenyl mesylate (200 mg, 0.754 mmol) and palladium acetate (169 mg, 0.754 mmol) were transferred into a sealable reaction vessel. The vessel was evacuated and backfilled with argon two times, and then opened under a positive flow of argon, and 10 mL anhydrous toluene was added via syringe. The mixture was stirred at 50° C. for 1 h. The appearance of an off-white suspension was indicative of complex formation. The reaction mixture was cooled to RT, and the solid was filtered through a frit. The solid was washed with addition 15 mL toluene to obtain pure compound as an off-white crystalline solid. Yield: 265 mg, 95%. ¹H NMR (500 MHz, CD₃CN) δ 7.64-7.59 (m, 1H), 7.46 (dd, J=7.6, 1.6 Hz, 1H), 7.44 (d, J=8.8 Hz, 1H), 7.30-7.25 (m, 2H), 7.21 (dd, J=7.8, 1.1 Hz, 1H), 7.16 (td, J=7.4, 1.2 Hz, 1H), 7.09 (td, J=7.5, 1.6 Hz, 1H), 6.49 (bs, 2H), 2.57 (s, 3H); ¹³C NMR (126 MHz, CD₃CN) δ 139.6, 139.1, 137.1, 136.7, 135.9, 128.2, 128.1, 127.4, 126.5, 126.3, 125.4, 120.8, and 39.4.

### μ-OMs Dimer of 2-ammonium-4′-(t-butyl)-[1,1′-biphenyl], 14

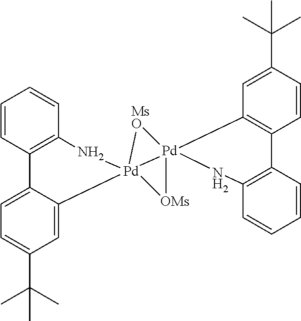

This compound was synthesized by a procedure similar to the synthesis of μ-OMs dimer of 2-ammoniumbiphenyl mesylate, above. Yield: 310 mg, 90%. ¹H NMR (500 MHz, CD₃CN) δ 7.64-7.59 (m, 1H), 7.52-7.43 (m, 1H), 7.43-7.38 (m, 1H), 7.30-7.25 (m, 2H), 7.20-7.17 (m, 1H), 7.14-7.11 (m, 1H), 6.47 (bs, 2H), 2.55 (s, 3H), 1.40 (s, 9H).

### Palladacycle 1, 15

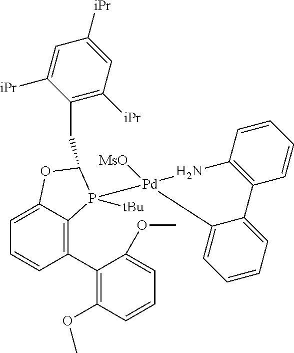

μ-OMs Dimer of 2-ammoniumbiphenyl mesylate (100 mg, 0.139 mmol) and Handaphos (37 mg, 0.068 mmol) were transferred to a sealable reaction vessel. The vessel was repeatedly sealed, evacuated and backfilled with argon at least three times. The vessel was opened under a positive flow of argon, and 10 mL dry DCM were added via syringe. The reaction vessel was then closed, and mixture was stirred at RT for 2 h. Solvent was then evaporated at RT under reduced pressure to obtain an off-white solid which was washed several times with dry pentane to obtain pure complex as an off-white solid, 110 mg (80%). ¹H NMR (500 MHz, CD₃OD) δ 8.10-8.07 (m, 1H), 7.82-7.80 (m, 1H), 7.36-7.33 (m, 2H), 7.31-7.30 (m, 2H), 7.06 (s, 2H), 6.95-6.87 (m, 3H), 6.87-6.85 (s, 2H), 6.85-6.83 (m, 2H), 6.70-6.68 (m, 1H), 5.12-5.05 (m, 1H), 3.60 (s, 3H), 3.23 (s, 3H), 2.87-2.65 (m, 3H), 2.38-2.25 (m, 1H), 2.20-1.88 (m, 4H), 1.71-0.65 (m, 27H); ³¹P NMR (162 MHz, CD₃OD) δ 63.2.

Low-level palladium catalyzed Suzuki-Miyaura cross couplings with palladacycle in water at room temperature:

### Procedure for Catalyst Preparation:

In 5.0 mL round-bottomed flask, catalyst (2.3 mg) was dissolved in 1.0 mL dry DMSO under the atmosphere of argon. Reaction mixture was stirred for a minute at RT. Catalyst solution was then ready to use.

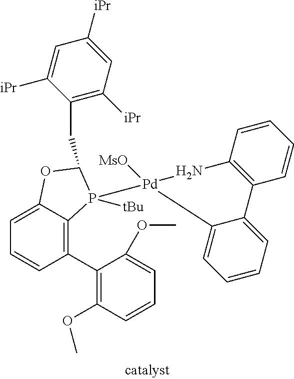

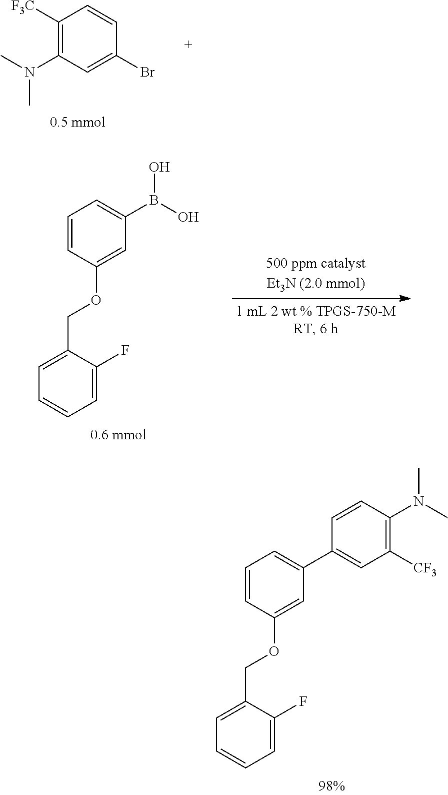 [SMILES: CN(C)c1cc(Br)ccc1C(F)(F)F ; OB(O)c1cccc(OCc2ccccc2F)c1 ; CN(C)c1ccc(-c2cccc(OCc3ccccc3F)c2)cc1C(F)(F)F]

To a 4.0 mL microwave reaction vial, the aryl bromide (0.5 mmol), aryl boronic acid (0.6 mmol) were added. The reaction vial was closed with a rubber septum, and argon was flushed through the vial with a vent needle. A 1.0 mL aqueous solution of 2 wt % TPGS-750-M, and then triethylamine (1.0 mmol) were sequentially added to the reaction vial. The mixture was stirred for 5 min at RT followed by addition of 100 μL catalyst solution (500 ppm Pd). The reaction mixture was then stirred vigorously at RT for 6 h.

After complete consumption of starting material as monitored by TLC (10% EtOAc/hexanes, R_{f}=0.35) or GCMS, 1.0 mL of EtOAc was added and the mixture was gently stirred for 2 mins at RT. Stirring was then stopped and the organic and aqueous layers were allowed to separate. The organic layer containing the desired product was separated using a Pasteur pipette. The same procedure was repeated three times. The combined organics were dried over anhydrous MgSO₄, and the volatiles were removed under reduced pressure to obtain semi-pure material, which was further purified by flash chromatography (7% EtOAc/hexanes) over silica gel; yield 199 mg, 98%.

While a number of exemplary embodiments, aspects and variations have been provided herein, those of skill in the art will recognize certain modifications, permutations, additions and combinations and certain sub-combinations of the embodiments, aspects and variations. It is intended that the following claims are interpreted to include all such modifications, permutations, additions and combinations and certain sub-combinations of the embodiments, aspects and variations are within their scope.

The entire disclosures of all documents cited throughout this application are incorporated herein by reference.

What is claimed is:

1. A ligand of the formula Ia, Ib, Ic or Id: 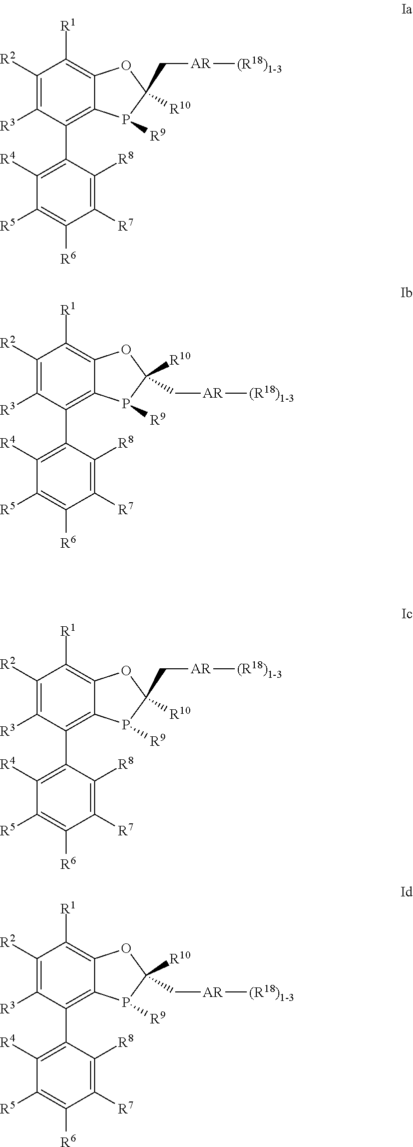
wherein:
AR is an unsubstituted or substituted (C₆₋₁₀)aryl or (C₅₋₁₁)heteroaryl group;
R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;
R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, —(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycloalkyl, aryl or heteroaryl ring;
R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;
R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;
R¹⁶ and R¹⁷ are each independently selected from the group consisting of hydrogen, perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted; and
each R¹⁸ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted;
as a single diastereomer or a mixture of diastereomers.

2. The ligand of claim 1, wherein:
AR is selected from the group consisting of phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole, each of which is unsubstituted or substituted with 1, 2 or 3 substituents selected from the group consisting of C₁₋₁₀alkyl, perhalo(C₁₋₃)alkyl, —O(C₁₋₁₀)alkyl, (C₂₋₁₀)alkenyl, (C₂₋₁₀)alkynyl and (C₃₋₁₂)cycloalkyl; and
R¹⁰ is hydrogen.

3. A ligand of the formula IIa, IIb, IIc or IId: 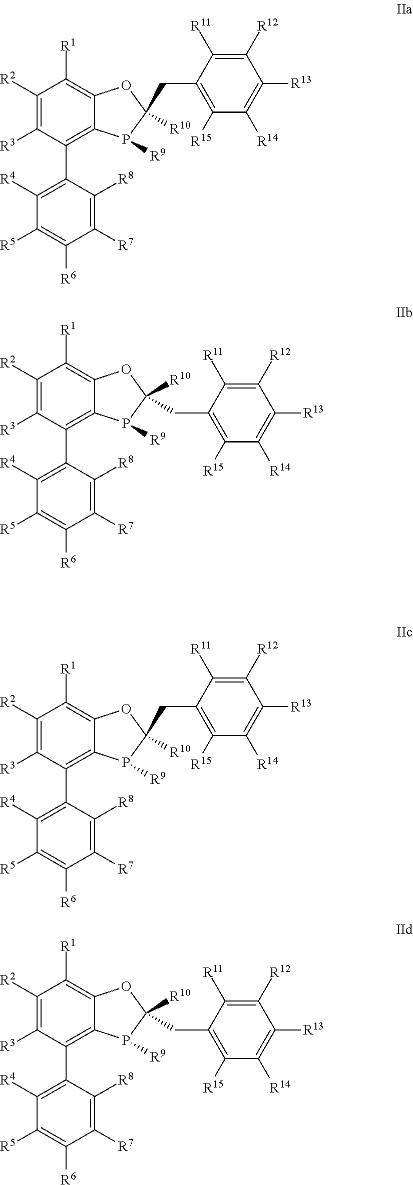
wherein:
R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;
R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycloalkyl, aryl or heteroaryl ring;
R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;
R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;
each R¹¹, R¹², R¹³, R¹⁴ and R¹⁵ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted; and
R¹⁶ and R¹⁷ are each independently selected from the group consisting of hydrogen, perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;
as a single diastereomer or a mixture of diastereomers.

4. The ligand of claim 3, wherein R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, cycloalkyl, aryl(C₁₋₁₀)alkyl, (C₉₋₁₂)bicycloaryl, (C₆₋₁₀)aryl, wherein each alkyl, alkenyl, alkynyl, cycloalkyl and aryl are unsubstituted or substituted with 1, 2 or 3 substituents selected from the group consisting of perhalo(C₁₋₃)alkyl, (C₁₋₁₀)alkyl and —O(C₁₋₁₀)alkyl.

5. The ligand of claim 4, wherein R⁹ is selected from the group consisting of —CH₃, —OCH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropy, cyclopentyl and -cyclohexyl.

6. The ligand of claim 3, wherein:
R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, cyclopentyl and -cyclohexyl;
R¹⁰ is hydrogen; and
R¹¹, R¹³ and R¹⁵ are each selected from the group consisting of —CH₃, —CH(CH₃)₂, —C(CH₃)₃, —C(CH₃)₂(CH₂CH₃), —C(CH₃)(CH₂CH₃)₂, —CH(CH(CH₃)₂) and —OCH₃.

7. The ligand of claim 3, wherein:
R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, -cyclopentyl and -cyclohexyl; and
R⁴, R⁶ and R⁸ are each independently selected from the group consisting of hydrogen, (C₁₋₁₀)alkyl and —O(C₁₋₆)alkyl.

8. The ligand of claim 3 selected from the group consisting of IIIa, IIIb, IIIc, IIId, IIIe, IIIf, IIIg and IIIh:

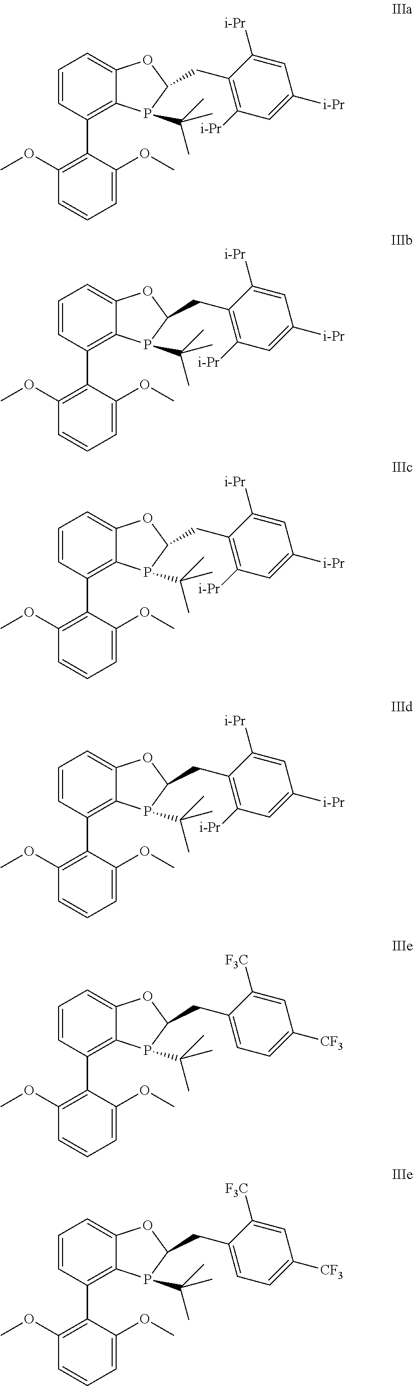 [SMILES: COc1cccc(OC)c1-c1cccc2c1[P@](C(C)(C)C)[C@@H](Cc1c(C(C)C)cc(C(C)C)cc1C(C)C)O2 ; COc1cccc(OC)c1-c1cccc2c1[P@](C(C)(C)C)[C@H](Cc1c(C(C)C)cc(C(C)C)cc1C(C)C)O2 ; COc1cccc(OC)c1-c1cccc2c1[P@@](C(C)(C)C)[C@@H](Cc1c(C(C)C)cc(C(C)C)cc1C(C)C)O2 ; COc1cccc(OC)c1-c1cccc2c1[P@@](C(C)(C)C)[C@H](Cc1c(C(C)C)cc(C(C)C)cc1C(C)C)O2 ; COc1cccc(OC)c1-c1cccc2c1[P@@](C(C)(C)C)[C@H](Cc1ccc(C(F)(F)F)cc1C(F)(F)F)O2 ; COc1cccc(OC)c1-c1cccc2c1[P@](C(C)(C)C)[C@H](Cc1ccc(C(F)(F)F)cc1C(F)(F)F)O2]

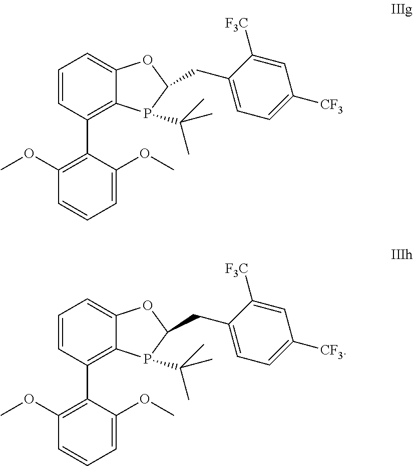 [SMILES: COc1cccc(OC)c1-c1cccc2c1[P@@](C(C)(C)C)[C@@H](Cc1ccc(C(F)(F)F)cc1C(F)(F)F)O2 ; COc1cccc(OC)c1-c1cccc2c1[P@@](C(C)(C)C)[C@H](Cc1ccc(C(F)(F)F)cc1C(F)(F)F)O2]

9. A palladacycle of the formula IVa, IVb, IVc or IVd: 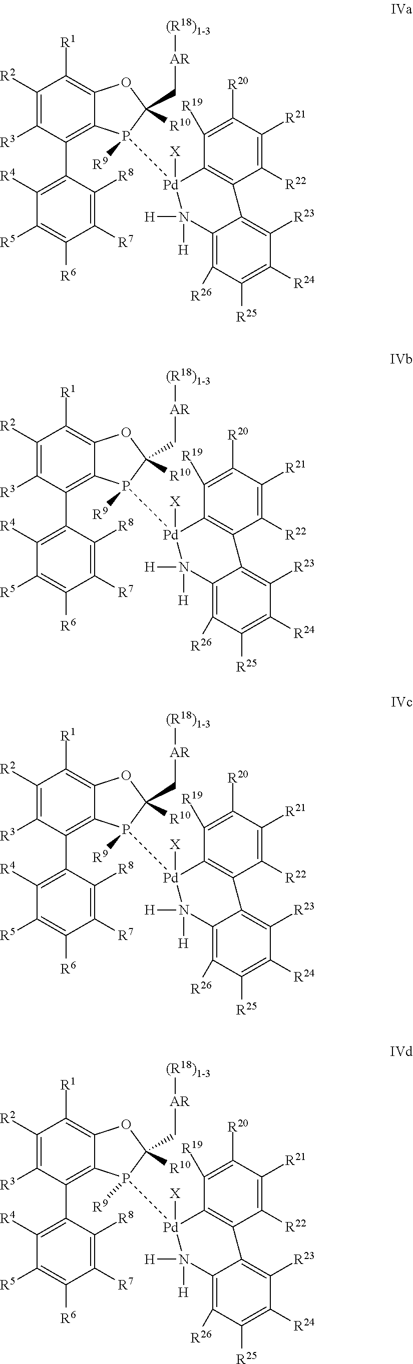
wherein:
AR is an unsubstituted or substituted (C₆₋₁₀)aryl or (C₅₋₁₁)heteroaryl group;
X is selected from the group consisting of Br, Cl, I, TsO— and MesO—;
R¹, R² and R³ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;
R⁴, R⁵, R⁶, R⁷ and R⁸ are each independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted, or where any two adjacent R⁴, R⁵, R⁶, R⁷ and R⁸ taken together with the carbon atoms to which they are bound to form a 5- or 6-membered substituted or unsubstituted cycoalkyl, aryl or heteroaryl ring;
R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl, (C₅₋₁₁)heteroaryl and ferrocenyl, wherein each alkyl, alkenyl, alkynyl, cycloalkyl, heterocycloalkyl, aryl, heteroaryl and ferrocenyl are unsubstituted or substituted;
R¹⁰ is selected from the group consisting of hydrogen, —Si(R¹⁶)₃, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;
R¹⁶ and R¹⁷ are each independently selected from the group consisting of hydrogen, perhalo(C₁₋₃)alkyl, (C₂₋₁₀)alkenyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, (C₆₋₁₀)aryl and (C₅₋₁₁)heteroaryl, wherein each alkyl, alkenyl, alkynyl, cycloalkyl, heterocycloalkyl, aryl and heteroaryl are unsubstituted or substituted;
each R¹⁸ is independently selected from the group consisting of hydrogen, halo, perhalo(C₁₋₃)alkyl, —NR¹⁶R¹⁷, —OR¹⁶, —SR¹⁶, —Si(R¹⁶)₃, —CN, —NO₂, —OH, (C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, (C₆₋₁₀)aryloxy and (C₅₋₁₁)heteroaryloxy, wherein each alkyl, alkenyl, alkynyl, cycloalkyl, heterocycloalkyl, aryl and heteroaryl are unsubstituted or substituted;
R¹⁹, R²⁰, R²¹ and R²² are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted; and
R²³, R²⁴, R²⁵ and R²⁶ are each independently selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted;
as a single diastereomer or a mixture of diastereomers.

10. The palladacycle of claim 9, wherein:
AR is selected from the group consisting of phenyl, 1-naphthyl, 2-naphthyl, furan, imidazole, isothiazole, isoxazole, oxadiazole, oxazole, 1,2,3-oxadiazole, pyrazine, pyrazole, pyridazine, pyridine, pyrimidine, pyrroline, thiazole, 1,3,4-thiadiazole, triazole and tetrazole, each of which is unsubstituted or substituted with 1, 2 or 3 substituents selected from the group consisting of C₁₋₁₀alkyl, perhalo(C₁₋₃)alkyl, —O(C₁₋₁₀)alkyl, (C₂₋₁₀)alkenyl, (C₂₋₁₀)alkynyl and (C₃₋₁₂)cycloalkyl; and
R¹⁰ is hydrogen.

11. The palladacycle of claim 9 or 10, wherein:
X is selected from the group consisting of Cl, TsO— and MesO—; and
R⁹ is selected from the group consisting of perhalo(C₁₋₃)alkyl, (C₁₋₁₀)alkyl, (C₂₋₁₀)alkenyl, (C₂₋₁₀)alkynyl, (C₃₋₁₂)cycloalkyl, cycloalkyl, aryl(C₁₋₁₀)alkyl, (C₉₋₁₂)bicycloaryl, (C₆₋₁₀)aryl, wherein each alkyl, alkenyl, alkynyl, cycloalkyl and aryl are unsubstituted or substituted with 1, 2 or 3 substituents selected from the group consisting of perhalo(C₁₋₃)alkyl, (C₁₋₁₀)alkyl and —O(C₁₋₁₀)alkyl.

12. The palladacycle of claim 9, wherein R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, cyclopentyl and -cyclohexyl.

13. The palladacycle of claim 9, wherein:
R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, cyclopentyl and -cyclohexyl;
R¹⁰ is hydrogen; and
R⁴ and R⁸ are each —CH(CH₃)₂ or —OCH₃.

14. The palladacycle of claim 9, wherein:
R⁹ is selected from the group consisting of —CH₃, —CH₂CH₃, —CH₂CH₂CH₃, —CH(CH₃)₂, —C(CH₃)₃, —C(CH₃)₂(CH₂CH₃), —C(CH₃)(CH₂CH₃)₂, —CH(CH(CH₃)₂), cyclopropyl, -cyclopentyl and -cyclohexyl; and
R⁴, R⁶ and R⁸ are each independently selected from the group consisting of hydrogen, (C₁₋₁₀)alkyl and —O(C₁₋₆)alkyl.

15.-22. (canceled)

23. A palladacycle catalyst prepared from the reaction of a ligand of claim 1 with a transition metal salt or a metal complex thereof, comprising contacting the ligand with the transition metal salt or the metal complex in a solvent for a sufficient period of time to form the palladacycle catalyst.

24. The palladacycle of claim 23, wherein the metal complex is: 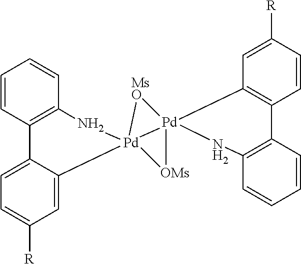
wherein R is selected from the group consisting of hydrogen, halo, perhalo(C₁₋₃)alkyl, —NR¹⁶R¹⁷, —CN, —NO₂, —OH, —S(C₁₋₁₀)alkyl, (C₁₋₁₀)alkyl, —O(C₁₋₁₀)alkyl, (C₂₋₁₀)alkenyl, (C₂₋₁₀)alkynyl, (C₃₋₁₂)cycloalkyl, hetero(C₃₋₁₂)cycloalkyl, aryl(C₁₋₁₀)alkyl, heteroaryl(C₁₋₅)alkyl, (C₉₋₁₂)bicycloaryl, hetero(C₈₋₁₂)bicycloaryl, —C(O)(C₁₋₃)alkyl, —C(S)(C₁₋₃)alkyl, —S(O)₁₋₂(C₁₋₃)alkyl, (C₆₋₁₀)aryl, (C₅₋₁₁)heteroaryl, aryloxy and (C₅₋₁₁)heteroaryloxy, wherein each alkyl, alkenyl, alkynyl, cycloalkyl, heterocycloalkyl, aryl and heteroaryl are unsubstituted or substituted.

25. The palladacycle of claim 23, wherein the ligand is selected from the group consisting of IIIA, IIIb, IIIc, IIId, IIIe, IIIf, IIIg and IIIb, or mixtures thereof:

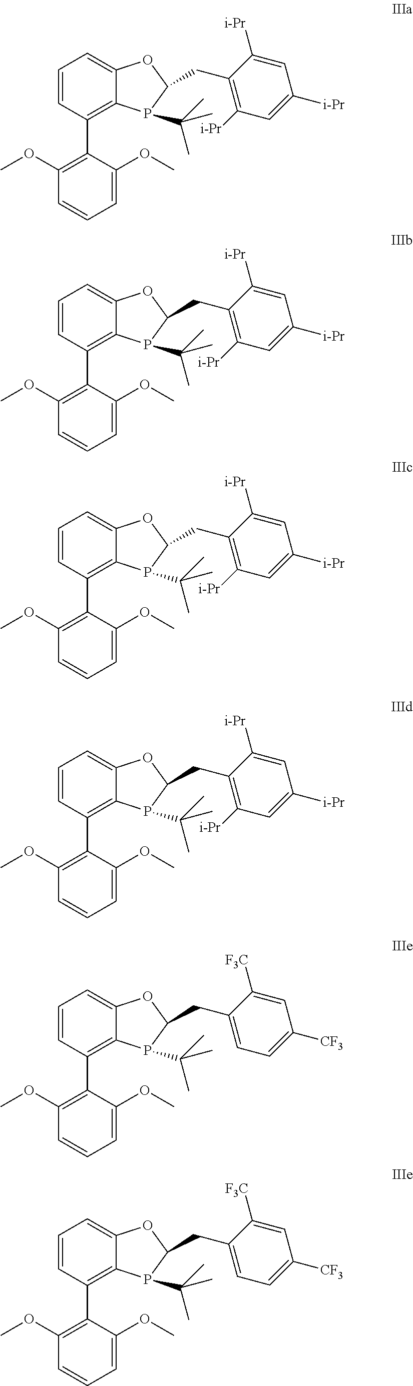 [SMILES: COc1cccc(OC)c1-c1cccc2c1[P@](C(C)(C)C)[C@@H](Cc1c(C(C)C)cc(C(C)C)cc1C(C)C)O2 ; COc1cccc(OC)c1-c1cccc2c1[P@](C(C)(C)C)[C@H](Cc1c(C(C)C)cc(C(C)C)cc1C(C)C)O2 ; COc1cccc(OC)c1-c1cccc2c1[P@@](C(C)(C)C)[C@@H](Cc1c(C(C)C)cc(C(C)C)cc1C(C)C)O2 ; COc1cccc(OC)c1-c1cccc2c1[P@@](C(C)(C)C)[C@H](Cc1c(C(C)C)cc(C(C)C)cc1C(C)C)O2 ; COc1cccc(OC)c1-c1cccc2c1[P@@](C(C)(C)C)[C@H](Cc1ccc(C(F)(F)F)cc1C(F)(F)F)O2 ; COc1cccc(OC)c1-c1cccc2c1[P@](C(C)(C)C)[C@H](Cc1ccc(C(F)(F)F)cc1C(F)(F)F)O2]

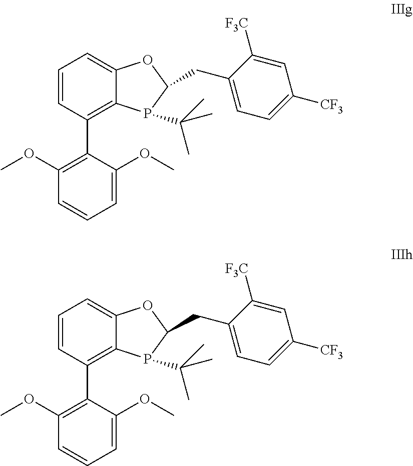 [SMILES: COc1cccc(OC)c1-c1cccc2c1[P@@](C(C)(C)C)[C@@H](Cc1ccc(C(F)(F)F)cc1C(F)(F)F)O2 ; COc1cccc(OC)c1-c1cccc2c1[P@@](C(C)(C)C)[C@H](Cc1ccc(C(F)(F)F)cc1C(F)(F)F)O2]

26.-41. (canceled)
